(19) United States
(12) Patent Application Publication
(10) Pub. No.: US 2026/0253418 A1
(43) Pub. Date: Aug. 27, 2026

(54) SYSTEM

(71) Applicant: SoftBank Group Corp., Tokyo (JP)

(72) Inventor: Shunji ISHIKAWA, Tokyo (JP)

(73) Assignee: SoftBank Group Corp., Tokyo (JP)

(21) Appl. No.: 19/534,856

(22) Filed: Feb. 10, 2026

(30) Foreign Application Priority Data
Feb. 21, 2025 (JP) 2025-027080

(51) Int. Cl. G06V 20/40; G06V 10/82; G10L 13/02; G10L 15/02; G10L 15/16; G10L 25/63

(52) U.S. Cl. CPC G06V 20/47; G06V 10/82; G06V 20/41; G10L 13/02; G10L 15/02; G10L 15/16; G10L 25/63

(57) ABSTRACT

The system according to the embodiment comprises a reception unit, an analysis unit, a generation unit, and a storage unit. The reception unit receives a designation of video content. The analysis unit analyzes the video content designated by the reception unit. The generation unit creates a summary based on the content analyzed by the analysis unit. The storage unit stores the summary generated by the generation unit.

### CROSS-REFERENCE TO RELATED APPLICATION

The present application claims priority to and incorporates by reference the entire contents of Japanese Patent Application No. 2025-027080 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that it is difficult to efficiently browse video content and extract necessary information.

### SUMMARY OF THE INVENTION

The system according to the embodiment comprises a reception unit, an analysis unit, a generation unit, and a storage unit. The reception unit receives a designation of video content. The analysis unit analyzes the video content designated by the reception unit. The generation unit creates a summary based on the content analyzed by the analysis unit. The storage unit stores the summary generated by the generation unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

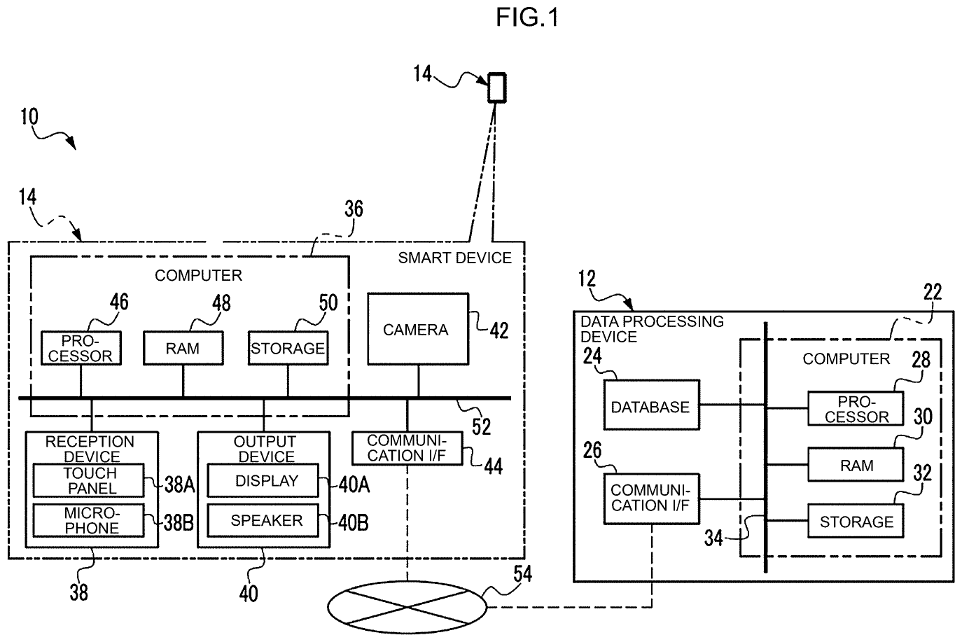

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

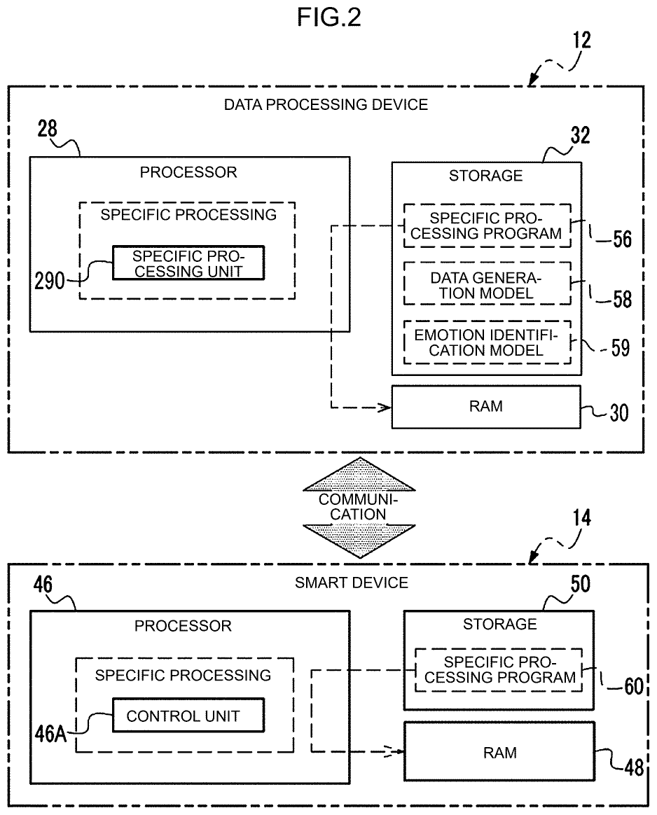

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention is a service that uses AI to view and analyze video content that users check daily, and summarizes the video content. In this system, the user designates the video content to be viewed to the AI, and the AI views the designated video content and analyzes its content. Based on the analyzed content, the AI creates a summary of the video. This summary is generated by transcription or speech synthesis. Furthermore, by saving the summary, it is possible to review the content even after the video content has been deleted. For example, the user designates “today's news video.” This information is input to the AI. Next, the AI views the designated video content and analyzes its content. The AI understands the content of the video and extracts important information. For example, in the case of a news video, the AI extracts major news items and important statements. Based on the analyzed content, the AI creates a summary of the video. The summary is generated by transcription or speech synthesis. For example, as a summary of a news video, a transcription listing the major news items or a speech-synthesized summary is generated. Furthermore, by saving the summary, it is possible to review the content even after the video content has been deleted. For example, the user can later check the summary of the saved news video. With this mechanism, the user no longer needs to watch videos at double speed, thereby saving time. In addition, since only important information is picked up, information can be obtained efficiently. For example, a busy businessperson can check the summary of a news video and grasp important information in a short time. Thus, the system can efficiently analyze video content that users check daily, and create and save summaries. Specifically, the system accepts input data such as the URL, video ID, title, and other metadata of the video content the user wishes to view via the reception unit. The reception unit preprocesses these input data and generates request parameters for obtaining video files or accessing streaming. The analysis unit divides the video data into frames or audio stream units and inputs them to the AI model as image tensors (e.g., 224×224×3 RGB image arrays) or audio spectrograms (e.g., per-second mel spectrogram arrays). As AI models, for example, convolutional neural networks (CNN) for image parts and recurrent neural networks (RNN) or transformer-based speech recognition models for audio parts can be used. These models perform multilayered analysis of scene changes, speaker utterances, subtitle text, acoustic events, etc., within the video, and output importance scores and labels (e.g., news items, speaker names, event types, etc.). For example, input examples include a video file of “news video at 18:00 on Jun. 1, 2024 (30 minutes)” or a live streaming URL in the “sports news” category. Output examples from the AI model include structured text such as “Main news items: economic policy announcement, international conference, weather warning” and “Important statements: Prime Minister's comments, expert explanations,” or “summary audio file (wav format).” The generation unit uses the output of the analysis unit and a natural language generation model (such as a large language model) to generate summary text (e.g., Japanese text within 500 characters) or scripts for speech synthesis. For speech synthesis, deep learning-based models such as WaveNet or Tacotron are used so that users can audibly check the summary. The storage unit saves the generated summary together with metadata (video ID, generation date and time, category, summary content, etc.) in a database or cloud storage. The storage formats can include structured data in JSON format, text files, audio files, etc. The saved summaries are indexed so that users can search and view them even if the video content is deleted. As a technical effect, this system achieves significant improvement in processing speed and uniformity of summary accuracy through high-dimensional feature extraction and automatic summary generation by AI, compared to conventional manual summarization or double-speed viewing by humans. Furthermore, personalized summary generation based on user designation and usage history enables efficient information acquisition and optimization of communication and storage load. Specific application fields include summary distribution of news videos, extraction of learning points from educational videos, automatic summarization of business meeting records, and highlight generation for entertainment videos. For training the AI model, supervised learning with summary datasets and domain adaptation by transfer learning can be used. In subsequent processing, the generated summary is used for display in the user interface, audio playback, search and filtering, API integration with other systems, etc. Thus, the present invention not only automates human tasks but also improves computer technology itself through a series of technical processes of non-conventional high-dimensional feature extraction, summary generation, and storage management by AI.

The video summary generation system according to the embodiment comprises a reception unit, an analysis unit, a generation unit, and a storage unit. The reception unit is configured to designate video content that the user wishes to view. For example, the user designates “today's news video.” This information is input to the reception unit. The analysis unit analyzes the video content designated by the reception unit. The analysis unit understands the content of the video and extracts important information. For example, in the case of a news video, the analysis unit extracts major news items and important statements. The generation unit creates a summary based on the content analyzed by the analysis unit. The summary is generated by transcription or speech synthesis. For example, as a summary of a news video, a transcription listing the major news items or a speech-synthesized summary is generated. The storage unit stores the summary generated by the generation unit. By saving the summary, the storage unit enables the user to review the content even after the video content has been deleted. For example, the user can later check the summary of the saved news video. Thus, the video summary generation system according to the embodiment can efficiently analyze video content that users check daily, and create and save summaries. Specifically, the video summary generation system accepts metadata such as the URL, video ID, title, category, and publication date of the video content from the user via the reception unit. The reception unit normalizes these input data and generates request parameters for obtaining video files or accessing streaming. The analysis unit divides the video data received from the reception unit into frame units (e.g., 30 frames per second, each frame is a 224×224×3 RGB image tensor) or audio stream units (e.g., per-second mel spectrogram arrays, 128 dimensions), and inputs them to the AI model. For image analysis, a convolutional neural network (CNN) is used, and for audio analysis, a recurrent neural network (RNN) or transformer-based speech recognition model is used. For example, the CNN detects scene changes and objects in the video, and the RNN or Transformer identifies speech content and speakers from audio. Input examples to the AI model include a video file of “news video at 18:00 on Jun. 1, 2024 (30 minutes)” or a live streaming URL in the “sports news” category. Output examples from the AI model include structured text such as “Main news items: economic policy announcement, international conference, weather warning” and “Important statements: Prime Minister's comments, expert explanations,” or “summary audio file (wav format).” The generation unit uses the output of the analysis unit and a natural language generation model such as a large language model to generate summary text (e.g., Japanese text within 500 characters) or scripts for speech synthesis. For speech synthesis, deep learning-based models such as WaveNet or Tacotron are used so that users can audibly check the summary. The storage unit saves the generated summary together with metadata such as video ID, generation date and time, category, and summary content in a database or cloud storage. The storage formats can include structured data in JSON format, text files, audio files, etc. The saved summaries are indexed so that users can search and view them even if the video content is deleted. As a technical effect, this system achieves significant improvement in processing speed and uniformity of summary accuracy through high-dimensional feature extraction and automatic summary generation by AI, compared to conventional manual summarization or double-speed viewing by humans. Furthermore, personalized summary generation based on user designation and usage history enables efficient information acquisition and optimization of communication and storage load. Specific application fields include summary distribution of news videos, extraction of learning points from educational videos, automatic summarization of business meeting records, and highlight generation for entertainment videos. For training the AI model, supervised learning with summary datasets and domain adaptation by transfer learning can be used. In subsequent processing, the generated summary is used for display in the user interface, audio playback, search and filtering, API integration with other systems, etc. Thus, the present invention not only automates human tasks but also improves computer technology itself through a series of technical processes of non-conventional high-dimensional feature extraction, summary generation, and storage management by AI.

The reception unit is configured to estimate a user's emotion and adjust a method for designating video content based on the estimated emotion of the user. For example, if the user is feeling stressed, the reception unit provides a simple interface and minimizes the steps required to designate video content. If the user is relaxed, the reception unit can provide detailed designation options and propose customizable designation methods. Furthermore, if the user is in a hurry, the reception unit can prioritize voice input to enable quick designation of video content. By adjusting the method for designating video content according to the user's emotion, more appropriate video content can be designated. Emotion estimation is realized, for example, by using an emotion engine or generative AI with emotion estimation functions. Generative AI may include text generation AI (e.g., LLM) or multimodal generative AI, but is not limited to these examples. Specifically, the reception unit accepts various multimodal data as input for estimating the user's emotion, such as user input text (e.g., video search queries, comments, chat history), audio data (e.g., speech waveform data, sampling rate 16 kHz, per-second audio clips), and facial or expression images (e.g., 224×224×3 RGB image tensors). The reception unit preprocesses and extracts features from these data, such as mel spectrogram conversion for audio, face region detection and expression feature extraction for images, and morphological analysis or emotion word dictionary matching for text. The reception unit integrates these feature vectors (e.g., 128-dimensional audio features, 256-dimensional image features, 300-dimensional text features) and inputs them to a multimodal emotion estimation model (e.g., transformer-based multimodal fusion network or hybrid CNN+RNN model). The reception unit receives outputs from the emotion estimation model, such as emotion labels (e.g., stress, relaxation, hurry, anger, sadness, joy), emotion intensity scores (e.g., continuous values from 0.0 to 1.0), and confidence scores. Input examples include “audio clip where the user says ‘I'm in a hurry,’” “text input ‘I want to see today's news immediately,’” and “smiling face image.” Output examples include “emotion label: hurry, score: 0.85” and “emotion label: relaxation, score: 0.65.” Based on these emotion estimation results, the reception unit dynamically switches the layout and input procedures of the user interface. For example, in cases of stress or hurry, one-click selection or voice input UI is prioritized, while in relaxation, detailed filters and customization options are expanded. The reception unit also links emotion estimation results to subsequent video recommendation modules and the analysis unit to optimize the overall user experience. As a technical effect, the reception unit achieves interaction optimization according to the user's real-time emotional state, reducing input error rates, shortening designation time, and improving user satisfaction, compared to conventional static UIs and uniform input procedures. Furthermore, multimodal datasets with emotion annotations and transfer learning can be used for training the emotion estimation model. Specific application fields include personalized recommendation of news videos, switching learning modes for educational videos, stress detection-based summary presentation for business meeting records, and mood-linked recommendations for entertainment videos. The present invention not only automates human tasks but also improves computer technology itself through a series of technical processes of high-dimensional feature extraction, multimodal emotion estimation, and dynamic UI control by AI.

The reception unit is configured to analyze a user's past video viewing history and automatically propose appropriate video content. For example, based on video content that the user has frequently viewed in the past, the reception unit proposes related new videos. The reception unit can also propose video content based on specific genres or themes derived from the user's viewing history. Furthermore, the reception unit can analyze the user's viewing history and propose video content tailored to the viewing time. By proposing optimal video content based on the user's past viewing history, video content suited to the user's interests can be provided. Some or all of the above-described processing in the reception unit may be performed using AI or without using AI. For example, the reception unit can input the user's viewing history data to generative AI and have the generative AI generate proposals for optimal video content. Specifically, the reception unit manages a video viewing history database for each user, with each history record storing structured data such as video ID, viewing date and time, playback time, genre, tags, device information, and viewing completion rate. The reception unit inputs these history data as time-series vectors (e.g., arrays of video IDs viewed in the past 30 days, one-hot vectors for each video's genre, viewing time histograms, etc.) to the AI model. Recommendation AI models such as collaborative filtering algorithms, graph neural networks, or transformer-based time-series recommendation models can be used. For example, a transformer model takes as input the user's past viewing sequence (e.g., embedded vector sequences of video IDs, genre embeddings, time embeddings) and outputs video IDs or genres with a high probability of being viewed next. Input examples include “sequence of news video IDs viewed in the past 30 days,” “educational video genres viewed on weekday evenings,” and “entertainment video IDs viewed on weekends.” Output examples include “recommended video ID: 12345, genre: news, recommendation score: 0.92” and “recommended video ID: 67890, genre: education, recommendation score: 0.85.” Based on the output scores from the AI model, the reception unit generates a recommended video list on the user interface and controls the order and emphasis according to the user's interest and usage history. Furthermore, the reception unit analyzes the user's viewing time and device usage trends to optimize recommendations for usage scenarios, such as “short news videos for morning commutes” and “long documentaries for nighttime.” As a technical effect, the reception unit achieves improved recommendation accuracy, reduced user churn rate, and enhanced video discoverability through high-dimensional feature extraction and time-series pattern learning by AI, compared to conventional static genre recommendations or simple history matching. For training the AI model, supervised learning with click/view completion labels and reinforcement learning for optimizing user responses can be used. Specific application fields include personalized recommendation of news videos, learning progress-linked recommendation for educational videos, trend discovery for entertainment videos, and automatic classification recommendation for business meeting records. The present invention not only automates human tasks but also improves computer technology itself through a series of technical processes of non-conventional high-dimensional history analysis, recommendation generation, and dynamic UI control by AI.

The reception unit is configured to perform filtering based on a user's current field of interest when designating video content. For example, the reception unit prioritizes the display of related video content based on topics the user is currently interested in. The reception unit can also propose related video content based on keywords recently searched by the user. Furthermore, the reception unit can prioritize the display of new videos from channels or creators followed by the user. By filtering video content based on the user's current field of interest, highly relevant videos can be provided. Some or all of the above-described processing in the reception unit may be performed using AI or without using AI. For example, the reception unit can input the user's field of interest data to generative AI and have the generative AI perform filtering of related video content. Specifically, the reception unit accepts various data as input for real-time estimation of the user's field of interest, such as recent search keyword history (e.g., sequence of search terms from the past 7 days), video viewing history (e.g., genre/tagged video ID arrays), and lists of followed channel IDs or creator IDs. The reception unit inputs these data as feature vectors (e.g., keyword embedding vectors, genre one-hot vectors, channel ID embeddings) to the AI model. For field of interest estimation, AI models such as BERT-based text classification models or graph neural networks can be used. Input examples include “search keywords: AI, education, health,” “viewed video genres: news, entertainment,” and “followed channels: education creator IDs.” The AI model outputs current interest topic labels (e.g., education, health, AI), interest scores (e.g., 0.8, 0.6, 0.4), and lists of related video IDs. Output examples include “interest topic: education, score: 0.85, related video IDs: 12345, 67890” and “interest topic: health, score: 0.75, related video IDs: 54321, 98765.” Based on these outputs, the reception unit prioritizes the display of highly relevant videos on the user interface and hides or lowers the display of unrelated videos. Furthermore, the reception unit tracks changes in the user's field of interest over time and dynamically updates filtering criteria according to trend changes. As a technical effect, the reception unit achieves improved recommendation accuracy, increased user satisfaction, and reduced information search cost through high-dimensional feature extraction and real-time interest estimation by AI, compared to conventional static genre filters or simple keyword matching. For training the AI model, supervised learning based on user click/view history and online learning for tracking changes in interest can be used. Specific application fields include topic-based recommendation of news videos, learning progress-linked recommendation of educational videos, trend-following recommendation of entertainment videos, and project-based filtering of business videos. The present invention not only automates human tasks but also improves computer technology itself through a series of technical processes of non-conventional high-dimensional interest estimation, dynamic filtering, and UI control by AI.

The reception unit is configured to estimate a user's emotion and determine a priority order of video content to be designated based on the estimated emotion of the user. For example, if the user is tired, the reception unit prioritizes the display of relaxing video content. If the user is excited, the reception unit can prioritize the display of highly entertaining video content. Furthermore, if the user is focused, the reception unit can prioritize the display of educational video content. By determining the priority order of video content according to the user's emotion, more appropriate video content can be provided. Emotion estimation is realized, for example, by using an emotion engine or generative AI with emotion estimation functions. Generative AI may include text generation AI (e.g., LLM) or multimodal generative AI, but is not limited to these examples. Some or all of the above-described processing in the reception unit may be performed using AI or without using AI. For example, the reception unit can input the user's emotion data to generative AI and have the generative AI determine the priority order of video content. Specifically, the reception unit accepts various multimodal data as input for estimating the user's emotion, such as user input text (e.g., video search queries, chat history), audio data (e.g., speech waveform data, per-second units), and facial images (e.g., 224×224×3 RGB image tensors). The reception unit preprocesses and extracts features from these data, such as mel spectrogram conversion for audio, face region detection and expression feature extraction for images, and emotion word dictionary matching or BERT-based emotion classification for text. The reception unit inputs these feature vectors to a multimodal emotion estimation model (e.g., transformer-based fusion network) and receives outputs such as emotion labels (e.g., fatigue, excitement, focus, relaxation) and emotion intensity scores. Input examples include “text: ‘I'm tired today,’” “smiling face image,” and “audio clip with excited voice.” Output examples include “emotion label: fatigue, score: 0.9” and “emotion label: excitement, score: 0.8.” Based on the emotion estimation results, the reception unit obtains attributes of each video (e.g., relaxation, entertainment, education) from the video metadata database and calculates priority scores according to matching rules between emotion labels and video attributes (e.g., fatigue→relaxation videos, excitement→entertainment videos, focus→educational videos). Based on the priority scores, the reception unit dynamically controls the order of the video list on the user interface and displays videos optimal for the user's emotional state at the top. As a technical effect, the reception unit achieves improved user satisfaction, shortened video selection time, and increased viewing continuation rate through high-dimensional emotion estimation and dynamic priority control by AI, compared to conventional static video recommendations or uniform ordering. For training the AI model, multimodal datasets with emotion annotations and transfer learning can be used. Specific application fields include mood-linked recommendation of news videos, concentration optimization recommendation of educational videos, and mood-changing recommendation of entertainment videos. The present invention not only automates human tasks but also improves computer technology itself through a series of technical processes of non-conventional high-dimensional emotion estimation, priority control, and dynamic UI integration by AI.

The reception unit is configured to preferentially designate highly relevant content based on a user's geographic location information when designating video content. For example, if the user is in a specific region, the reception unit prioritizes the display of video content related to that region. If the user is traveling, the reception unit can propose travel information or guide videos related to the travel destination. Furthermore, if the user is participating in a specific event, the reception unit can prioritize the display of video content related to that event. By providing highly relevant video content based on the user's geographic location information, more appropriate video content can be offered. Some or all of the above-described processing in the reception unit may be performed using AI or without using AI. For example, the reception unit can input the user's geographic location information to generative AI and have the generative AI designate highly relevant content. Specifically, the reception unit accepts geographic location data as input, such as GPS coordinates (e.g., latitude 35.6895, longitude 139.6917) obtained from the user terminal, Wi-Fi access point information, and region codes estimated from IP addresses. The reception unit normalizes these geographic location data in the preprocessing unit, converts latitude and longitude to area IDs or city codes on a map, and matches them with event location or tourist spot databases. The reception unit generates geographic location feature vectors (e.g., area ID vectors, event ID one-hot vectors, region attribute embedding vectors) and inputs them to a geographic relevance estimation AI model (e.g., graph neural network or transformer-based geographic information fusion model). The reception unit receives outputs from the AI model, such as lists of video IDs with relevance scores (e.g., video ID 12345, relevance 0.92, region: Tokyo), event labels (e.g., fireworks festival, academic conference), and tourist spot categories (e.g., museum, restaurant introduction). Input examples include “user's current location: Kyoto city, event: Gion Festival ongoing” and “user's travel destination: Sapporo, Hokkaido, for sightseeing.” Output examples include “related video ID: 56789, event: Gion Festival, relevance: 0.95” and “related video ID: 98765, tourist spot: Sapporo Clock Tower, relevance: 0.88.” Based on these outputs, the reception unit prioritizes the display of region-related videos on the user interface and lowers or hides unrelated videos. Furthermore, the reception unit analyzes the user's movement history and length of stay over time and can recommend videos optimized for usage scenarios, such as “in-depth videos about long-stay locations” and “guide videos for short-stay locations.” As a technical effect, the reception unit achieves improved recommendation accuracy, increased user satisfaction, and reduced information search cost through high-dimensional geographic information feature extraction and real-time relevance estimation by AI, compared to conventional static genre recommendations or simple keyword matching. For training the AI model, geographically annotated video datasets, supervised learning combining location information and viewing history, and online learning for tracking regional trends can be used. Specific application fields include automatic recommendation of regional news videos, location-linked distribution of tourist guide videos, exclusive video recommendations for event participants, and prioritized display of emergency information videos by region during disasters. The present invention not only automates human tasks but also improves computer technology itself through a series of technical processes of non-conventional geographic information analysis, relevance estimation, and dynamic UI control by AI.

The reception unit is configured to analyze a user's social media activity and propose related content when designating video content. For example, the reception unit proposes new videos from accounts followed by the user on social media. The reception unit can also propose related videos based on content shared by the user on social media. Furthermore, the reception unit can propose videos related to groups or communities the user participates in on social media. By providing related video content based on the user's social media activity, more appropriate video content can be offered. Some or all of the above-described processing in the reception unit may be performed using AI or without using AI. For example, the reception unit can input the user's social media activity data to generative AI and have the generative AI propose related content. Specifically, the reception unit accepts various social data as input, such as lists of followed account IDs obtained from linked social media accounts, posting history (e.g., the last 30 post texts, shared video IDs), group participation IDs, like history, and comment history. The reception unit normalizes these data in the preprocessing unit, maps account IDs to creator IDs of video distribution services, and vectorizes post texts through morphological analysis or keyword extraction. The reception unit generates social feature vectors (e.g., follow relationship graph embeddings, post keyword vectors, group attribute one-hot vectors) and inputs them to a social relevance estimation AI model (e.g., graph neural network or BERT-based text classification model). The reception unit receives outputs from the AI model, such as lists of related video IDs (e.g., video ID 12345, relevance 0.93, followed creator: Creator A), topic labels (e.g., education, entertainment, news), and group relevance scores. Input examples include “followed account: education creator ID, recent post: impressions of AI education video,” and “participating group: business study group.” Output examples include “related video ID: 67890, topic: education, relevance: 0.91” and “related video ID: 54321, group: business study group, relevance: 0.87.” Based on these outputs, the reception unit prioritizes the display of socially related videos on the user interface and lowers or hides unrelated videos. Furthermore, the reception unit analyzes time-series changes and trends in the user's social activity and can recommend videos optimized for usage scenarios, such as “videos frequently shared recently” and “videos related to newly joined groups.” As a technical effect, the reception unit achieves improved recommendation accuracy, increased user satisfaction, and reduced information search cost through high-dimensional social feature extraction and real-time relevance estimation by AI, compared to conventional static genre recommendations or simple history matching. For training the AI model, socially annotated video datasets, supervised learning combining social activity and viewing history, and online learning for tracking trends can be used. Specific application fields include automatic recommendation of new videos from followed creators, group activity-linked video distribution, personalized recommendation based on share history, and prioritized display of community event videos. The present invention not only automates human tasks but also improves computer technology itself through a series of technical processes of non-conventional high-dimensional social data analysis, relevance estimation, and dynamic UI control by AI.

The analysis unit is configured to estimate a user's emotion and adjust the accuracy of analysis based on the estimated emotion of the user. For example, if the user is relaxed, the analysis unit performs detailed analysis and extracts more information. If the user is in a hurry, the analysis unit can quickly analyze and focus on important information. Furthermore, if the user is excited, the analysis unit can prioritize the extraction of visually stimulating information. By adjusting the accuracy of analysis according to the user's emotion, more appropriate analysis results can be provided. Emotion estimation is realized, for example, by using an emotion engine or generative AI with emotion estimation functions. Generative AI may include text generation AI (e.g., LLM) or multimodal generative AI, but is not limited to these examples. Some or all of the above-described processing in the analysis unit may be performed using AI or without using AI. For example, the analysis unit can input the user's emotion data to generative AI and have the generative AI adjust the accuracy of analysis. Specifically, the analysis unit accepts various multimodal data as input for estimating the user's emotion, such as user input text (e.g., video search queries, chat history) received from the reception unit, audio data (e.g., speech waveform data, sampling rate 16 kHz, per-second audio clips), and facial images (e.g., 224×224×3 RGB image tensors). The analysis unit normalizes these data in the preprocessing unit, performs mel spectrogram conversion for audio, face region detection and expression feature extraction for images, and morphological analysis or emotion word dictionary matching for text. The analysis unit integrates these feature vectors (e.g., 128-dimensional audio features, 256-dimensional image features, 300-dimensional text features) and inputs them to a multimodal emotion estimation model (e.g., transformer-based multimodal fusion network or hybrid CNN+RNN model). The analysis unit receives outputs from the emotion estimation model, such as emotion labels (e.g., relaxation, hurry, excitement, tension, sadness, joy), emotion intensity scores (e.g., continuous values from 0.0 to 1.0), and confidence scores. Input examples include “audio clip where the user says ‘I'm in a hurry,’” “text input ‘I want to see today's news immediately,’” and “smiling face image.” Output examples include “emotion label: hurry, score: 0.85” and “emotion label: relaxation, score: 0.65.” Based on the emotion estimation results, the analysis unit controls branching in the analysis pipeline. For example, in a relaxed state, the analysis unit performs detailed scene analysis for each frame of the entire video (e.g., 30 frames per second, each frame is a 224×224×3 image tensor), full speech recognition (e.g., full transcription), speaker identification, object detection, subtitle analysis, and multilayered feature extraction. In a hurry, the analysis unit extracts only parts with high importance scores, such as scene change detection and important statement extraction, to reduce processing load. In an excited state, the analysis unit prioritizes the extraction of visually and audibly stimulating features, such as scenes with vivid colors or large movements, and parts with emphasized background music or sound effects. These adjustments to analysis accuracy are realized by dynamically switching AI model parameters (e.g., analysis window width, thresholds, number of extracted features) and algorithm selection (e.g., detailed analysis mode/fast analysis mode). Output examples from the AI model include “detailed analysis: 10 major news items+full transcription,” “fast analysis: only 3 key points extracted,” and “stimulating scenes: cut numbers 12, 25, 38.” In subsequent processing, the output of the analysis unit is passed to the generation unit for summary text generation, speech synthesis, and display control in the user interface. As a technical effect, the analysis unit achieves optimal analysis accuracy according to the user's real-time emotional state, efficient use of computational resources, shortened analysis time, and improved user satisfaction, compared to conventional uniform analysis processing. Furthermore, multimodal datasets with emotion annotations and transfer learning can be used for training the emotion estimation model. Specific application fields include dynamic control of summary accuracy for news videos, optimization of learning modes for educational videos, highlight extraction for entertainment videos, and stress detection-linked summarization for business meeting records. The present invention not only automates human tasks but also improves computer technology itself through a series of non-conventional technical processes of high-dimensional feature extraction, emotion estimation, and analysis accuracy control by AI.

The analysis unit is configured to apply different analysis algorithms according to the content of the video during analysis. For example, in the case of news videos, the analysis unit applies an algorithm to extract major news items. For educational videos, the analysis unit can apply an algorithm to extract important learning points. Furthermore, for entertainment videos, the analysis unit can apply an algorithm to extract visually attractive scenes. By applying analysis algorithms according to the content of the video, the accuracy of analysis is improved. Some or all of the above-described processing in the analysis unit may be performed using AI or without using AI. For example, the analysis unit can input video content data to generative AI and have the generative AI apply different analysis algorithms. Specifically, the analysis unit accepts video metadata (e.g., video ID, title, category, tag, publication date) and the video file itself received from the reception unit as input data. For content classification of the video, the analysis unit first inputs thumbnail images, initial frames, initial audio tracks, title/description text, etc., to a multimodal classification AI model combining BERT-based text classification, CNN-based image classification, and audio feature extraction models. The analysis unit receives outputs from the AI model, such as category labels (e.g., news, education, entertainment), content topics (e.g., economy, sports, science, music), and confidence scores. Input examples include “title: Jun. 1, 2024 news,” “thumbnail image: news studio,” and “initial audio: news jingle.” Output examples include “category: news, score: 0.92” and “category: education, score: 0.85.” Based on the content classification results, the analysis unit controls branching in the algorithm selection module. For news videos, the analysis unit applies algorithms for major news item extraction using speech recognition (ASR) and natural language processing (NLP) (e.g., key phrase extraction, speaker identification, time-series summarization). For educational videos, the analysis unit applies algorithms for lecture slide detection, blackboard region extraction, and automatic summarization of learning points (e.g., important keyword extraction, Q&A section detection). For entertainment videos, the analysis unit applies algorithms for scene change detection, face/object detection, color/motion feature extraction, and visually attractive scene ranking (e.g., highlight scoring). These algorithms are implemented by combining AI models such as CNN, RNN, and Transformer, and optimized pipelines are constructed for each video category. Output examples from the AI model include “main news items: economic policy announcement, international conference,” “learning points: definition A, theorem B, exercise C,” and “highlight scenes: cut numbers 12, 25, 38.” In subsequent processing, the analysis results are passed to the generation unit for summary text generation, speech synthesis, and display control in the user interface. As a technical effect, the analysis unit achieves improved analysis accuracy, reduced false detection rate, and efficient use of computational resources through optimal algorithm application according to video content, compared to conventional uniform analysis processing. For training the AI model, category-annotated video datasets and transfer learning can be used. Specific application fields include automatic summarization of news videos, extraction of learning points from educational videos, highlight generation for entertainment videos, and summarization of business video minutes. The present invention not only automates human tasks but also improves computer technology itself through a series of technical processes of non-conventional content classification, algorithm branching, and high-dimensional feature extraction by AI.

The analysis unit is configured to apply different important information extraction methods for each video category during analysis. For example, in the news category, the analysis unit extracts major news items and important statements. In the education category, the analysis unit can extract important learning points and keywords. Furthermore, in the entertainment category, the analysis unit can extract visually attractive scenes and interesting moments. By applying important information extraction methods according to the video category, the accuracy of analysis is improved. Some or all of the above-described processing in the analysis unit may be performed using AI or without using AI. For example, the analysis unit can input video category data to generative AI and have the generative AI apply important information extraction methods. Specifically, the analysis unit accepts input data such as video category labels (e.g., news, education, entertainment), video ID, title, tag, and publication date received from the reception unit. The analysis unit has an important information extraction pipeline optimized for each category. For the news category, the analysis unit performs full transcription using speech recognition (ASR) and applies key phrase extraction, speaker identification, and time-series summarization algorithms using natural language processing (NLP). For the education category, the analysis unit applies slide region detection by image analysis, text extraction (OCR), important keyword extraction, and Q&A section detection algorithms. For the entertainment category, the analysis unit applies scene change detection, face/object detection, color/motion feature extraction, and interesting moment ranking algorithms (e.g., laughter detection, applause detection, visual effect emphasis). These extraction methods are implemented by combining AI models such as CNN, RNN, and Transformer, and parameters and thresholds are optimized for each category. Input examples to the AI model include “news category: audio stream of 30-minute news video,” “education category: slide images of lecture video,” and “entertainment category: frame sequence of variety video.” Output examples from the AI model include “main news items: economic policy announcement, international conference,” “learning points: definition A, theorem B, exercise C,” and “interesting moments: cut numbers 12, 25, 38.” The analysis unit generates the extraction results as structured data and passes them to the generation unit for summary text generation, speech synthesis, and display control in the user interface. As a technical effect, the analysis unit achieves improved analysis accuracy, reduced false detection rate, and increased user satisfaction through application of optimized extraction methods for each category, compared to conventional uniform information extraction. For training the AI model, category-annotated video datasets and transfer learning can be used. Specific application fields include automatic summarization of news videos, extraction of learning points from educational videos, highlight generation for entertainment videos, and summarization of business video minutes. The present invention not only automates human tasks but also improves computer technology itself through a series of technical processes of non-conventional category branching, high-dimensional feature extraction, and important information extraction by AI.

The analysis unit is configured to estimate a user's emotion and adjust a display method of analysis results based on the estimated emotion of the user. For example, if the user is tense, the analysis unit provides a simple and highly visible display method. If the user is relaxed, the analysis unit can provide a display method that includes detailed information. Furthermore, if the user is in a hurry, the analysis unit can provide a display method that focuses on key points. By adjusting the display method of analysis results according to the user's emotion, more appropriate display can be achieved. Emotion estimation is realized, for example, by using an emotion engine or generative AI with emotion estimation functions. Generative AI may include text generation AI (e.g., LLM) or multimodal generative AI, but is not limited to these examples. Some or all of the above-described processing in the analysis unit may be performed using AI or without using AI. For example, the analysis unit can input the user's emotion data to generative AI and have the generative AI adjust the display method of analysis results. Specifically, the analysis unit accepts emotion estimation results (e.g., emotion label, emotion intensity score, confidence score) received from the reception unit as input data. The analysis unit dynamically selects display templates and UI layouts for analysis results according to emotion labels (e.g., tension, relaxation, hurry, excitement, sadness, joy). For example, in a tense state, the analysis unit generates a simple UI that displays only key points in large font and with limited colors. In a relaxed state, the analysis unit generates a rich UI that includes detailed information (e.g., full transcription, related topics, charts). In a hurry, the analysis unit displays only important items in a bulleted list and provides interaction for one-click transition to detailed display. These display controls are realized in the user interface generation module based on AI model outputs (e.g., display item list, emphasis score, UI layout parameters). Input examples include “emotion label: tension, score: 0.8” and “emotion label: relaxation, score: 0.7.” Output examples include “display template: simple, key points only” and “display template: detailed, full text+charts.” In subsequent processing, the analysis unit links analysis results and display control information to the generation unit and storage unit to optimize the overall user experience. As a technical effect, the analysis unit achieves optimized display according to the user's real-time emotional state, improved information comprehension, reduced operation error rate, and increased user satisfaction, compared to conventional static UIs and uniform display methods. For training the AI model, datasets with annotations of emotion states and UI preferences and online learning can be used. Specific application fields include optimization of summary display for news videos, UI for switching learning modes in educational videos, highlight emphasis display for entertainment videos, and key point display for business video minutes. The present invention not only automates human tasks but also improves computer technology itself through a series of technical processes of high-dimensional emotion estimation, dynamic UI control, and display optimization by AI.

The analysis unit is configured to perform analysis based on the geographic distribution of the video during analysis. For example, the analysis unit extracts important information for each region based on the shooting location of the video. If the content of the video is related to a specific region, the analysis unit can extract information specific to that region. Furthermore, if the viewers of the video are concentrated in a specific region, the analysis unit can prioritize the extraction of information related to that region. By considering the geographic distribution of the video, important information for each region can be extracted. Some or all of the above-described processing in the analysis unit may be performed using AI or without using AI. For example, the analysis unit can input geographic distribution data of the video to generative AI and have the generative AI perform analysis. Specifically, the analysis unit accepts geographic distribution data as input, such as shooting location information (e.g., GPS coordinates, city code, area ID), video metadata (e.g., title, tag, publication date), and viewer distribution data (e.g., region-based view count heatmap, region estimation from IP addresses) received from the reception unit or storage unit. The analysis unit normalizes these data in the preprocessing unit, converts latitude and longitude to area IDs or city codes on a map, and generates region attribute embedding vectors. Furthermore, the analysis unit structures viewer distribution data as time-series vectors or histograms and inputs them to a geographic relevance estimation AI model (e.g., graph neural network or transformer-based geographic information fusion model). The analysis unit receives outputs from the AI model, such as important information labels for each region (e.g., Tokyo: economic news, Kyoto: tourism events), region-based importance scores (e.g., 0.92, 0.85), and lists of related video IDs. Input examples include “shooting location: Sapporo, viewer distribution: centered in Hokkaido” and “tag: Gion Festival, area ID: Kyoto.” Output examples include “region: Sapporo, important information: Snow Festival, score: 0.88” and “region: Kyoto, important information: Gion Festival, score: 0.95.” Based on these outputs, the analysis unit controls branching in the analysis pipeline optimized for each region and executes region-specific summarization and highlight extraction. In subsequent processing, the analysis unit links region-based analysis results to the generation unit and storage unit for use in regional news summarization, tourist guide video generation, and region-limited distribution. As a technical effect, the analysis unit achieves improved analysis accuracy, increased discoverability of regional information, and increased user satisfaction through high-dimensional feature extraction and region-specific analysis considering geographic distribution, compared to conventional uniform analysis processing. For training the AI model, geographically annotated video datasets, supervised learning combining region-based viewing history, and online learning for tracking regional trends can be used. Specific application fields include automatic summarization of regional news videos, location-linked analysis of tourist guide videos, region-based highlight extraction for event videos, and region-based emergency information analysis during disasters. The present invention not only automates human tasks but also improves computer technology itself through a series of technical processes of non-conventional geographic information analysis, high-dimensional feature extraction, and region-specific processing by AI.

The analysis unit is configured to improve the accuracy of analysis based on related literature of the video during analysis. For example, the analysis unit refers to academic papers related to the content of the video to supplement important information. The analysis unit can also refer to news articles related to the content of the video to add the latest information. Furthermore, the analysis unit can refer to books related to the content of the video to supplement detailed information. By referring to related literature, the accuracy of analysis is improved. Some or all of the above-described processing in the analysis unit may be performed using AI or without using AI. For example, the analysis unit can input related literature data of the video to generative AI and have the generative AI improve the accuracy of analysis. Specifically, the analysis unit obtains related literature data (e.g., paper title, abstract, author, publication year, article text, book excerpt) from external academic paper databases, news article APIs, and e-book databases based on video content metadata (e.g., title, keyword, category, tag) received from the reception unit or storage unit. The analysis unit normalizes these literature data in the preprocessing unit and generates text embedding vectors (e.g., BERT-based 768-dimensional vectors), keyword vectors, and topic distribution vectors. Furthermore, the analysis unit inputs feature vectors of video content and literature to a multimodal relevance estimation AI model (e.g., cross-modal transformer, similarity calculation network) and receives outputs such as relevance scores and supplementary information labels. Input examples include “video title: AI-based medical diagnosis” and “keywords: deep learning, image analysis.” Output examples include “related paper: Deep Learning in Medical Image Diagnosis, relevance: 0.93” and “related news: Latest AI Medical Device Approval, relevance: 0.88.” The analysis unit extracts important information from highly relevant literature and adds it as supplementary information to the video analysis results. For example, the analysis unit summarizes abstracts and charts from academic papers, latest trends from news articles, and detailed explanations from books, and integrates them into the analysis results. In subsequent processing, the analysis unit links analysis results with supplementary information to the generation unit and storage unit for summary text generation, detailed explanation, and reference literature display in the user interface. As a technical effect, the analysis unit achieves improved analysis accuracy, increased information coverage, and increased user satisfaction through high-dimensional information supplementation using external knowledge resources, compared to conventional analysis targeting only video content. For training the AI model, datasets with relevance annotations for video-literature pairs and transfer learning can be used. Specific application fields include academic supplementary summarization for educational videos, latest information supplementation for news videos, detailed explanation generation for specialized videos, and reference material link generation for business videos. The present invention not only automates human tasks but also improves computer technology itself through a series of technical processes of non-conventional external knowledge integration, high-dimensional feature extraction, and information supplementation by AI.

The generation unit is configured to estimate a user's emotion and adjust a method for expressing the summary based on the estimated emotion of the user. For example, if the user is relaxed, the generation unit generates a summary that progresses at a leisurely pace. If the user is in a hurry, the generation unit can generate a concise summary focused on important information. Furthermore, if the user is excited, the generation unit can generate a summary with visually stimulating effects. By adjusting the method for expressing the summary according to the user's emotion, more appropriate summaries can be provided. Emotion estimation is realized, for example, by using an emotion engine or generative AI with emotion estimation functions. Generative AI may include text generation AI (e.g., LLM) or multimodal generative AI, but is not limited to these examples. Some or all of the above-described processing in the generation unit may be performed using AI or without using AI. For example, the generation unit can input the user's emotion data to generative AI and have the generative AI adjust the method for expressing the summary. Specifically, the generation unit accepts emotion estimation results (e.g., emotion label, emotion intensity score, confidence score) received from the reception unit or analysis unit as input data. Based on the emotion estimation results, the generation unit dynamically determines summary generation parameters (e.g., writing style, tone, progression speed, effect intensity, presence of visual elements). For example, in a relaxed state, the generation unit adds prompts to the natural language generation model (such as a large language model) instructing “polite and calm tone,” “detailed explanation,” and “leisurely progression,” and sets slow and soft voice parameters for the speech synthesis model. In a hurry, the generation unit generates prompts such as “concise summary,” “extract only key points,” and “short sentence structure,” and applies fast and clear voice parameters to the speech synthesis model. In an excited state, the generation unit generates scripts or metadata for inserting emphasized phrases and visual effects (e.g., color emphasis, animation), and applies dynamic effects to the video summary thumbnail or UI. Input examples to the AI include “emotion label: relaxation, score: 0.7,” “emotion label: hurry, score: 0.9,” and “emotion label: excitement, score: 0.8.” Output examples from the AI include “summary style: polite/detailed, progression speed: slow,” “summary style: concise/key points only, progression speed: fast,” and “summary style: with emphasized phrases, effect: color emphasis.” Based on these outputs, the generation unit automatically sets parameters for the summary generation algorithm (e.g., summary length, style template, speech synthesis speed, effect script) and controls branching in the summary generation pipeline. In subsequent processing, the generated summary is linked to the storage unit and user interface and presented in an expression optimized for the user's emotional state. As a technical effect, the generation unit achieves optimized expression according to the user's real-time emotional state, improved information comprehension, increased user satisfaction, and reduced operation error rate, compared to conventional uniform summary generation. Furthermore, datasets with annotations of emotion states and expression preferences and online learning can be used for training the emotion estimation model and summary generation model. Specific application fields include mood-linked summarization for news videos, learning mode-optimized summaries for educational videos, mood-changing summary generation for entertainment videos, and stress-relief summarization for business videos. The present invention not only automates human tasks but also improves computer technology itself through a series of technical processes of high-dimensional emotion estimation, dynamic summary expression control, and non-conventional generation pipelines by AI.

The generation unit is configured to adjust a level of detail of the summary based on the importance of the video when generating the summary. For example, for important news videos, the generation unit generates a detailed summary. For general entertainment videos, the generation unit can generate a concise summary. Furthermore, for educational videos, the generation unit can generate a summary that explains learning points in detail. By adjusting the level of detail of the summary according to the importance of the video, more appropriate summaries can be provided. Some or all of the above-described processing in the generation unit may be performed using AI or without using AI. For example, the generation unit can input video importance data to generative AI and have the generative AI adjust the level of detail of the summary. Specifically, the generation unit accepts metadata such as importance scores of the video (e.g., continuous values from 0.0 to 1.0), category labels, user-specified priority, and attention indicators based on viewing history received from the analysis unit as input data. Based on these importance data, the generation unit dynamically determines summary generation parameters (e.g., summary length, level of detail, presence of explanatory text, chart insertion, information density for speech synthesis). For example, for news videos with high importance scores, the generation unit adds prompts to the natural language generation model instructing “detailed summary,” “comprehensive coverage of all major items,” and “with explanation of grounds,” and generates scripts with high information density for the speech synthesis model. For entertainment videos with low importance, the generation unit generates prompts such as “concise summary,” “key points only,” and “short sentence structure,” and applies shortened and simplified scripts to the speech synthesis model. For educational videos, the generation unit generates prompts such as “detailed explanation of learning points,” “term explanation,” and “emphasis on Q&A sections,” and inserts summary of charts or slide images. Input examples to the AI include “video ID: 12345, importance: 0.95, category: news,” “video ID: 67890, importance: 0.60, category: entertainment,” and “video ID: 54321, importance: 0.88, category: education.” Output examples from the AI include “summary length: 1000 characters, level of detail: high, charts: included,” “summary length: 200 characters, level of detail: low, charts: none,” and “summary length: 800 characters, level of detail: medium, learning points: 3 items.” Based on these outputs, the generation unit automatically sets parameters for the summary generation algorithm (e.g., summary length, level of detail, inserted elements) and controls branching in the summary generation pipeline. In subsequent processing, the generated summary is linked to the storage unit and user interface and presented with an optimal level of detail according to the importance of the video. As a technical effect, the generation unit achieves optimized level of detail according to the importance of each video, improved information coverage, increased user satisfaction, and reduced information search cost, compared to conventional uniform summary generation. Furthermore, datasets with importance annotations for videos and online learning can be used for training the importance estimation model and summary generation model. Specific application fields include detailed summarization of urgent news videos, emphasis on learning points in educational video summaries, simplified highlight generation for entertainment videos, and summarization of business video minutes. The present invention not only automates human tasks but also improves computer technology itself through a series of technical processes of high-dimensional importance estimation, dynamic summary detail control, and non-conventional generation pipelines by AI.

The generation unit is configured to apply different summary generation algorithms according to the category of the video when generating the summary. For example, for the news category, the generation unit generates a summary listing the major news items. For the education category, the generation unit can generate a summary that explains important learning points in detail. Furthermore, for the entertainment category, the generation unit can generate a summary that emphasizes visually attractive scenes. By applying summary generation algorithms according to the category of the video, more appropriate summaries can be provided. Some or all of the above-described processing in the generation unit may be performed using AI or without using AI. For example, the generation unit can input video category data to generative AI and have the generative AI apply summary generation algorithms. Specifically, the generation unit accepts metadata such as category labels of the video (e.g., news, education, entertainment), video ID, title, tag, and publication date received from the analysis unit as input data. The generation unit has a summary generation pipeline optimized for each category. For the news category, the generation unit adds prompts to the natural language generation model instructing “list major items,” “summary by speaker,” and “time-series summary,” and sets news-announcer-style voice parameters for the speech synthesis model. For the education category, the generation unit generates prompts such as “detailed explanation of learning points,” “term explanation,” and “emphasis on Q&A sections,” and inserts summary of charts or slide images. For the entertainment category, the generation unit generates prompts such as “emphasis on highlight scenes,” “insertion of visual effects,” and “ranking of interesting moments,” and applies dynamic effects to the video summary thumbnail or UI. Input examples to the AI include “category: news, video ID: 12345,” “category: education, video ID: 67890,” and “category: entertainment, video ID: 54321.” Output examples from the AI include “summary format: bulleted list, 5 major items,” “summary format: detailed explanation, 3 learning points,” and “summary format: highlight emphasis, effect: color emphasis.” Based on these outputs, the generation unit automatically selects summary generation algorithms and parameters (e.g., summary format, emphasis elements, inserted content) and controls branching in the summary generation pipeline. In subsequent processing, the generated summary is linked to the storage unit and user interface and presented in an expression optimized for each category. As a technical effect, the generation unit achieves improved analysis accuracy, increased user satisfaction, and reduced information search cost through optimal algorithm application for each video category, compared to conventional uniform summary generation. Furthermore, datasets with category annotations for videos and online learning can be used for training the category classification model and summary generation model. Specific application fields include automatic summarization of news videos, extraction and summarization of learning points from educational videos, highlight generation for entertainment videos, and summarization of business video minutes. The present invention not only automates human tasks but also improves computer technology itself through a series of technical processes of non-conventional category branching, high-dimensional feature extraction, and dynamic summary generation by AI.

The generation unit is configured to estimate a user's emotion and adjust a length of the summary based on the estimated emotion of the user. For example, if the user is in a hurry, the generation unit generates a short summary that focuses on key points. If the user is relaxed, the generation unit can generate a longer summary that includes detailed explanations. Furthermore, if the user is excited, the generation unit can generate a summary with visually stimulating effects. By adjusting the length of the summary according to the user's emotion, more appropriate summaries can be provided. Emotion estimation is realized, for example, by using an emotion engine or generative AI with emotion estimation functions. Generative AI may include text generation AI (e.g., LLM) or multimodal generative AI, but is not limited to these examples. Some or all of the above-described processing in the generation unit may be performed using AI or without using AI. For example, the generation unit can input the user's emotion data to generative AI and have the generative AI adjust the length of the summary. Specifically, the generation unit accepts emotion estimation results (e.g., emotion label, emotion intensity score, confidence score) received from the reception unit or analysis unit as input data. Based on the emotion estimation results, the generation unit dynamically determines summary generation parameters (e.g., summary length, number of sentences, level of detail, effect intensity). For example, in a hurry, the generation unit adds prompts to the natural language generation model instructing “key points only,” “short sentence structure,” and “maximum 200 characters,” and sets fast and concise voice parameters for the speech synthesis model. In a relaxed state, the generation unit generates prompts such as “detailed explanation,” “long sentence structure,” and “maximum 1000 characters,” and applies slow and soft voice parameters to the speech synthesis model. In an excited state, the generation unit generates prompts such as “insertion of emphasized phrases,” “emphasis on effects,” and “medium to long sentence structure,” and applies dynamic effects to the video summary thumbnail or UI. Input examples to the AI include “emotion label: hurry, score: 0.9,” “emotion label: relaxation, score: 0.7,” and “emotion label: excitement, score: 0.8.” Output examples from the AI include “summary length: 150 characters, level of detail: low,” “summary length: 900 characters, level of detail: high,” and “summary length: 500 characters, effect: emphasis.” Based on these outputs, the generation unit automatically sets parameters for the summary generation algorithm (e.g., summary length, level of detail, effect) and controls branching in the summary generation pipeline. In subsequent processing, the generated summary is linked to the storage unit and user interface and presented with a length optimized for the user's emotional state. As a technical effect, the generation unit achieves optimized summary length according to the user's real-time emotional state, improved information comprehension, increased user satisfaction, and reduced operation error rate, compared to conventional uniform summary length. Furthermore, datasets with annotations of emotion states and summary length preferences and online learning can be used for training the emotion estimation model and summary generation model. Specific application fields include dynamic control of summary length for news videos, learning mode-optimized summaries for educational videos, highlight emphasis summary generation for entertainment videos, and stress-relief summarization for business videos. The present invention not only automates human tasks but also improves computer technology itself through a series of technical processes of high-dimensional emotion estimation, dynamic summary length control, and non-conventional generation pipelines by AI.

The generation unit is configured to determine a priority order of the summary based on the submission timing of the video when generating the summary. For example, for the latest video content, the generation unit generates the summary with priority. The generation unit can also determine the order of summary generation based on user-specified deadlines. Furthermore, for videos related to specific events, the generation unit can generate the summary before the event. By determining the priority order of the summary based on the submission timing of the video, more appropriate summaries can be provided. Some or all of the above-described processing in the generation unit may be performed using AI or without using AI. For example, the generation unit can input video submission timing data to generative AI and have the generative AI determine the priority order of the summary. Specifically, the generation unit accepts time-series metadata such as video submission date and time, publication date and time, event date and time, and user-specified deadlines received from the reception unit or storage unit as input data. Based on these time-series data, the generation unit calculates priority scores for the summary generation queue (e.g., recency of submission date, remaining time until event, urgency of user-specified deadline) and dynamically controls the execution order of the summary generation pipeline. For the latest videos, the generation unit maximizes the priority score and instructs immediate summary generation. If the user-specified deadline is approaching, the generation unit increases the priority according to the remaining time, and for event-related videos, the generation unit schedules summary generation to be completed before the event date. Input examples to the AI include “video ID: 12345, submission date: 2024-06-01T18:00, event date: 2024-06-02T10:00” and “video ID: 67890, user deadline: 2024-06-03T12:00.” Output examples from the AI include “priority score: 0.95, generation order: 1st” and “priority score: 0.80, generation order: 2nd.” Based on these outputs, the generation unit links priority information to the summary generation job scheduler and optimizes the allocation order of parallel processing clusters and GPU resources. In subsequent processing, the generated summary is linked to the storage unit and user interface and presented at a timing that meets the needs of the user or event. As a technical effect, the generation unit achieves optimized priority based on time-series metadata, improved information freshness, increased user satisfaction, and efficient use of computational resources, compared to conventional first-come-first-served or uniform batch processing. Furthermore, datasets with annotations of submission timing and user response and online learning can be used for training the priority estimation model and scheduler. Specific application fields include immediate summarization of breaking news videos, pre-event summary generation for event videos, deadline-linked summarization for business videos, and pre-class summary generation for educational videos. The present invention not only automates human tasks but also improves computer technology itself through a series of technical processes of high-dimensional time-series analysis, dynamic priority control, and non-conventional generation pipelines by AI.

The generation unit can adjust the order of summaries during summary generation based on the relevance of videos. For example, the generation unit can preferentially summarize highly relevant video content. Additionally, the generation unit can prioritize summarizing videos related to topics of interest to the user. Furthermore, the generation unit can prioritize summarizing videos from channels or creators followed by the user. By adjusting the order of summaries based on video relevance, more appropriate summaries can be provided. Some or all of the above-described processing in the generation unit may be performed using AI or without using AI. For example, the generation unit can input video relevance data into a generation AI and have the generation AI execute the adjustment of summary order. Specifically, the generation unit receives input data such as video relevance scores (e.g., continuous values from 0.0 to 1.0), user interest topic labels, followed channel IDs, creator IDs, and search keyword history, which are received from the reception unit or analysis unit. Based on this relevance data, the generation unit dynamically determines the order of the summary generation queue (e.g., descending relevance score, topic match priority, followed source priority, etc.). For example, videos with high relevance scores are set to higher positions in the summary generation order, and videos matching the user's interest topics or from followed creators have their priority increased. Examples of AI input include “Video ID: 12345, Relevance: 0.93, Topic: Education” and “Video ID: 67890, Relevance: 0.85, Followed Source: Creator A.” Examples of AI output include “Generation Order: 1st, Reason: Topic Match & High Relevance” and “Generation Order: 2nd, Reason: Followed Source Priority.” Based on these outputs, the generation unit links order information to the summary generation job scheduler and optimizes the allocation order of parallel processing clusters or GPU resources. In subsequent processing, the generated summaries are linked to the storage unit or user interface and presented in an order that reflects the user's interests and usage history. As a technical effect, the generation unit achieves order optimization based on relevance data compared to conventional uniform summary generation order, resulting in improved information discoverability, increased user satisfaction, and efficient use of computational resources. Furthermore, relevance annotation video datasets and online learning can be used for training relevance estimation models and schedulers. Specific application fields include personalized video summary list generation, topic-based summary distribution, prioritized summary generation for new works by followed creators, and project-based summary order optimization for business videos. The present invention is not merely automation of human tasks, but realizes improvement of computer technology itself through a series of technical processes including high-dimensional relevance estimation by AI, dynamic order control, and unconventional generation pipelines.

The storage unit can estimate the user's emotion and determine the priority order of summaries to be stored based on the estimated emotion of the user. For example, the storage unit can preferentially store summaries that the user feels are important. Additionally, if the user is relaxed, the storage unit can preferentially store detailed summaries. Furthermore, if the user is in a hurry, the storage unit can preferentially store concise summaries. By determining the priority order of summaries to be stored according to the user's emotion, more important summaries can be stored preferentially. Emotion estimation is realized, for example, by using an emotion engine or a generation AI with emotion estimation functionality. The generation AI may be a text generation AI (e.g., LLM) or a multimodal generation AI, but is not limited to these examples. Some or all of the above-described processing in the storage unit may be performed using AI or without using AI. For example, the storage unit can input the user's emotion data into a generation AI and have the generation AI determine the priority order of summaries. Specifically, the storage unit receives input data such as the user's emotion estimation results (e.g., emotion label, emotion intensity score, confidence score) from the reception unit or analysis unit. Based on the emotion estimation results, the storage unit dynamically determines parameters for calculating the priority score of summaries to be stored (e.g., continuous values from 0.0 to 1.0). For example, if the emotion label is estimated as “important,” an “importance flag” is added to the summary content and the priority score is maximized. In a relaxed state, a high priority is assigned to detailed summaries (e.g., full transcription or summaries with detailed explanations). In a hurry, priority is given to concise summaries that extract only the main points. Examples of AI input include “Emotion label: Important, Score: 0.95,” “Emotion label: Relaxed, Score: 0.7,” and “Emotion label: In a hurry, Score: 0.85.” Examples of AI output include “Storage priority: High, Reason: Important emotion,” “Storage priority: Medium, Reason: Detailed summary,” and “Storage priority: Low, Reason: Concise summary.” Based on these outputs, the storage unit automatically controls the order of the storage queue and storage allocation, storing summaries in cloud or local storage in order of priority. Furthermore, the storage unit adds metadata to the summaries to be stored (e.g., emotion label, priority score, storage date and time, category, etc.), enabling optimization based on priority in subsequent search, viewing, and deletion processes. As a technical effect, the storage unit achieves optimization of storage priority according to the user's real-time emotional state, preventing omission of important information, efficient use of storage resources, and increased user satisfaction, compared to conventional uniform storage order and static storage rules. Additionally, emotion estimation models and storage priority estimation models can be trained using datasets annotated with emotion states and storage behaviors, as well as online learning. Specific application fields include prioritized storage of important summaries for emergency news videos, storage of detailed summaries for educational videos, storage of simple highlights for entertainment videos, and prioritized storage of important minutes for business videos by project. The present invention is not merely automation of human tasks, but realizes improvement of computer technology itself through a series of technical processes including high-dimensional emotion estimation by AI, dynamic storage priority control, and unconventional storage pipelines.

The storage unit can adjust the storage method based on the importance of the summary at the time of storage. For example, important summaries are stored in cloud storage and made accessible at any time. Additionally, general summaries can be stored in local storage and made accessible offline. Furthermore, temporary summaries can be stored so that they are automatically deleted after a certain period. By adjusting the storage method based on the importance of the summary, more appropriate storage is possible. Some or all of the above-described processing in the storage unit may be performed using AI or without using AI. For example, the storage unit can input summary importance data into a generation AI and have the generation AI adjust the storage method. Specifically, the storage unit receives input data such as summary importance scores (e.g., continuous values from 0.0 to 1.0), category labels, user-specified priority, and attention indicators based on viewing history, which are received from the generation unit or analysis unit. Based on this importance data, the storage unit dynamically determines storage method parameters (e.g., type of storage destination, storage period, access permissions, backup availability, etc.). For example, for summaries with high importance scores, multiple copies are stored in cloud storage or distributed file systems to ensure redundancy and availability. For general summaries, they are stored in the user's local storage or temporary cache area, prioritizing offline access and fast retrieval. For temporary summaries, expiration metadata (e.g., storage date+7 days) is added at the time of storage, and an automatic deletion job is executed when the expiration date arrives. Examples of AI input include “Summary ID: 12345, Importance: 0.95,” “Summary ID: 67890, Importance: 0.60,” and “Summary ID: 54321, Importance: 0.30.” Examples of AI output include “Storage destination: Cloud, Storage period: Unlimited,” “Storage destination: Local, Storage period: 30 days,” and “Storage destination: Temporary cache, Storage period: 7 days.” Based on these outputs, the storage unit automatically sets the storage destination and storage period in the storage management module and controls branching of the storage pipeline. Furthermore, the storage unit dynamically sets access permissions and backup policies for each storage destination to reduce the risk of loss of important summaries. As a technical effect, the storage unit achieves optimization of storage methods according to the importance of each summary, efficient use of storage resources, reduction of information loss risk, and increased user satisfaction, compared to conventional uniform storage methods and static storage allocation. Additionally, importance estimation models and storage management models can be trained using importance-annotated summary datasets and online learning. Specific application fields include multiple storage of emergency news summaries, long-term storage of educational video summaries, temporary storage of entertainment video highlights, and time-limited storage of business minutes. The present invention is not merely automation of human tasks, but realizes improvement of computer technology itself through a series of technical processes including high-dimensional importance estimation by AI, dynamic storage method control, and unconventional storage management.

The storage unit can apply different storage methods for each summary category at the time of storage. For example, summaries in the news category are organized and stored by date. Additionally, summaries in the education category can be stored by dividing them into folders by topic. Furthermore, summaries in the entertainment category can be stored in order of popularity based on the number of views. By applying storage methods according to the summary category, more appropriate storage is possible. Some or all of the above-described processing in the storage unit may be performed using AI or without using AI. For example, the storage unit can input summary category data into a generation AI and have the generation AI apply the storage method. Specifically, the storage unit receives input data such as category labels (e.g., news, education, entertainment, etc.), summary ID, title, tag, publication date, and number of views, which are received from the generation unit or analysis unit. Based on this category data, the storage unit dynamically determines storage method parameters (e.g., folder structure, storage destination directory, order, index key, etc.). For example, in the news category, folders are automatically created by publication or issue date, and a date-ordered index is generated. In the education category, subfolders are created by topic or subject name, and related summaries are grouped. In the entertainment category, summaries are sorted by number of views or user evaluation score and stored with rankings. Examples of AI input include “Summary ID: 12345, Category: News, Publication Date: 2024-06-01,” “Summary ID: 67890, Category: Education, Topic: AI,” and “Summary ID: 54321, Category: Entertainment, Views: 1000.” Examples of AI output include “Storage destination: /news/2024-06-01/”, “Storage destination: /education/AI/”, and “Storage destination: /entertainment/ranking/1/”. Based on these outputs, the storage unit automatically sets the storage destination directory and index in the file system management module and controls branching of the storage pipeline. Furthermore, the storage unit optimizes the search, viewing, and deletion interfaces for each category, enabling users to quickly access the desired summary. As a technical effect, the storage unit achieves optimal application of storage methods for each category, reduction of information search costs, improvement of search efficiency, and increased user satisfaction, compared to conventional uniform storage structures and static folder organization. Additionally, category classification models and storage method optimization models can be trained using category-annotated summary datasets and online learning. Specific application fields include date-based archiving of news summaries, topic-based organization of educational video summaries, popularity-based storage of entertainment video highlights, and project-based storage of business minutes. The present invention is not merely automation of human tasks, but realizes improvement of computer technology itself through a series of technical processes including high-dimensional category classification by AI, dynamic storage method control, and unconventional file management.

The storage unit can estimate the user's emotion and adjust the display method of summaries to be stored based on the estimated emotion of the user. For example, if the user is relaxed, a display method including detailed information is provided. Additionally, if the user is in a hurry, a concise display method focusing on key points can be provided. Furthermore, if the user is excited, a display method with visually stimulating effects can be provided. By adjusting the display method of summaries to be stored according to the user's emotion, more appropriate display is possible. Emotion estimation is realized, for example, by using an emotion engine or a generation AI with emotion estimation functionality. The generation AI may be a text generation AI (e.g., LLM) or a multimodal generation AI, but is not limited to these examples. Some or all of the above-described processing in the storage unit may be performed using AI or without using AI. For example, the storage unit can input the user's emotion data into a generation AI and have the generation AI adjust the display method of summaries. Specifically, the storage unit receives input data such as the user's emotion estimation results (e.g., emotion label, emotion intensity score, confidence score) from the reception unit or analysis unit. Based on the emotion estimation results, the storage unit dynamically determines summary display parameters (e.g., display template type, font size, color emphasis level, effect presence, detail level, etc.). For example, in a relaxed state, a rich UI template including detailed information (e.g., full transcription, charts, related topics) is selected, and colors and fonts are set to calm tones. In a hurry, only key points are displayed in large font as bullet points, and an interaction is provided to transition to detailed display with one click. In an excited state, a dynamic UI is generated with emphasized phrases and visual effects (e.g., color emphasis, animation). Examples of AI input include “Emotion label: Relaxed, Score: 0.7,” “Emotion label: In a hurry, Score: 0.9,” and “Emotion label: Excited, Score: 0.8.” Examples of AI output include “Display template: Detailed, Color: Calm,” “Display template: Key points only, Font: Large,” and “Display template: Emphasis effect, Animation: Yes.” Based on these outputs, the storage unit automatically sets the display layout and effects in the user interface generation module and controls branching of the summary display pipeline. Furthermore, the storage unit learns user display preferences for each emotional state and reflects them in future display optimization. As a technical effect, the storage unit achieves display optimization according to the user's real-time emotional state, improving information comprehension, reducing operation error rate, and increasing user satisfaction, compared to conventional static UIs and uniform display methods. Additionally, emotion estimation models and UI optimization models can be trained using datasets annotated with emotion states and display preferences, as well as online learning. Specific application fields include optimization of summary display for news summaries, UI for switching learning modes in educational video summaries, emphasis effect display for entertainment video highlights, and key point emphasis display for business minutes. The present invention is not merely automation of human tasks, but realizes improvement of computer technology itself through a series of technical processes including high-dimensional emotion estimation by AI, dynamic UI control, and display optimization.

The storage unit can perform storage based on the geographic distribution of summaries at the time of storage. For example, when a user stores summaries related to a specific region, they are organized and stored by region. Additionally, when a user saves summaries while traveling, they can be stored in folders by travel destination. Furthermore, when a user stores summaries related to a specific event, they can be organized and stored by event. By considering the geographic distribution of summaries, storage organized by region becomes possible. Some or all of the above-described processing in the storage unit may be performed using AI or without using AI. For example, the storage unit can input summary geographic distribution data into a generation AI and have the generation AI perform the storage. Specifically, the storage unit receives input data such as summary geographic distribution data (e.g., shooting location GPS coordinates, city code, area ID, event ID, storage date and time) from the reception unit or analysis unit. Based on this geographic distribution data, the storage unit dynamically determines storage destination directories and folder structures (e.g., by region, city, event). For example, for summaries related to a specific region, folders are automatically created by city code or area ID, and a region-based index is generated. For summaries saved during travel, subfolders are created by travel destination, and a storage structure linked to travel history is constructed. For event-related summaries, they are organized by event ID or event name, and an event-based archive is generated. Examples of AI input include “Summary ID: 12345, Region: Tokyo, Event: Fireworks Festival” and “Summary ID: 67890, Region: Sapporo, Travel Destination: Hokkaido.” Examples of AI output include “Storage destination: /tokyo/hanabi/” and “Storage destination: /hokkaido/trip/”. Based on these outputs, the storage unit automatically sets the storage destination directory and index in the file system management module and controls branching of the storage pipeline. Furthermore, the storage unit optimizes the search, viewing, and sharing interfaces for each geographic distribution, enabling users to efficiently manage summaries by region or event. As a technical effect, the storage unit achieves dynamic storage optimization according to geographic distribution, reduction of information search costs, improvement of regional information discoverability, and increased user satisfaction, compared to conventional uniform storage structures and static folder organization. Additionally, geographic information analysis models and storage structure optimization models can be trained using geographically annotated summary datasets and online learning. Specific application fields include region-based storage of regional news summaries, travel destination-based organization of tourist guide summaries, event-based archiving of event video summaries, and region-based storage of emergency information during disasters. The present invention is not merely automation of human tasks, but realizes improvement of computer technology itself through a series of technical processes including high-dimensional geographic information analysis by AI, dynamic storage structure control, and unconventional file management.

The storage unit can refer to related literature when storing summaries to improve the accuracy of storage. For example, the storage unit can refer to academic papers related to the content of the summary and supplement important information during storage. Additionally, the storage unit can refer to news articles related to the content of the summary and add the latest information. Furthermore, the storage unit can refer to books related to the content of the summary and supplement detailed information. By referring to related literature, the accuracy of storage is improved. Some or all of the above-described processing in the storage unit may be performed using AI or without using AI. For example, the storage unit can input summary-related literature data into a generation AI and have the generation AI improve the accuracy of storage. Specifically, the storage unit uses summary content metadata (e.g., title, keywords, category, tags) received from the generation unit or analysis unit to obtain related literature data (e.g., paper title, abstract, author, publication year, article text, book excerpt, etc.) from external academic paper databases, news article APIs, electronic book databases, etc. The storage unit normalizes these literature data in a preprocessing unit and generates text embedding vectors (e.g., BERT-based 768-dimensional vectors), keyword vectors, and topic distribution vectors. Furthermore, the summary content feature vectors and literature feature vectors are input into a multimodal relevance estimation AI model (e.g., cross-modal Transformer, similarity calculation network), which outputs relevance scores and supplementary information labels. Examples of AI input include “Summary Title: AI-based Medical Diagnosis,” “Keywords: Deep Learning, Image Analysis,” etc. Examples of AI output include “Related Paper: Deep Learning in Medical Image Diagnosis, Relevance: 0.93,” “Related News: Latest AI Medical Device Approval, Relevance: 0.88,” etc. The storage unit extracts important information from highly relevant literature and adds it as supplementary information when storing the summary. For example, abstracts and charts from academic papers, latest trends from news articles, and detailed explanations from books are summarized and integrated into the summary metadata. Furthermore, the storage unit automatically generates reference lists and related information links during storage, allowing users to directly refer to related literature from the stored summary. As a technical effect, the storage unit achieves improved storage accuracy, increased information coverage, and increased user satisfaction by utilizing external knowledge resources for high-dimensional information supplementation, compared to conventional storage targeting only summary content. Additionally, relevance estimation models and information supplementation models can be trained using datasets annotated with summary-literature pairs and relevance scores, as well as transfer learning. Specific application fields include academic supplementation storage for educational video summaries, latest information supplementation storage for news video summaries, detailed explanation storage for specialized video summaries, and reference material link storage for business video summaries. The present invention is not merely automation of human tasks, but realizes improvement of computer technology itself through a series of technical processes including unconventional external knowledge integration, high-dimensional feature extraction, and information supplementation by AI.

The system according to the embodiment is not limited to the examples described above and can be variously modified as follows. Specifically, the system can flexibly change the architecture of AI models, data flow, and the configuration of storage, analysis, and generation pipelines according to the type of video content, user attributes, and usage environment. For example, the same summarization, storage, and recommendation processing can be applied to audio content or text content other than video. Additionally, user attributes such as age group, field of expertise, and presence of disabilities can be considered to dynamically adjust accessibility optimization and the degree of personalization. Furthermore, in terms of usage environment, the system can be embedded in mobile devices, wearable devices, in-vehicle systems, and can support various hardware and network configurations such as distributed processing by edge AI and large-scale parallel processing via cloud collaboration. Variations of AI models may include multimodal fusion models for images, audio, and text, time-series prediction models, anomaly detection models, and reinforcement learning-based recommendation models. Each module of the storage unit, analysis unit, and generation unit can enhance interoperability and scalability with other systems through API integration and microservices. As a technical effect, the system achieves flexible configuration changes, support for diverse data types, optimization of personalization degree, and efficient distributed processing, greatly improving the efficiency and accuracy of information acquisition, management, and utilization compared to conventional static video summarization and storage systems. Specific application fields include summarization of medical records in medical settings, automatic organization of minutes in legal fields, individualized learning support in educational settings, multimedia summary distribution in entertainment fields, and emergency information summary distribution during disasters. The present invention is not merely automation of human tasks, but realizes improvement of computer technology itself through a series of technical processes including high-dimensional feature extraction by AI, dynamic pipeline control, and unconventional system configuration optimization.

The reception unit can monitor the user's health status and adjust the method for designating video content based on the health status. For example, if the user is fatigued, relaxing video content is proposed. Additionally, if the user is exercising, exercise videos can be preferentially displayed. Furthermore, if the user is ill, videos containing health information can be proposed. By providing appropriate video content according to the user's health status, the system can better serve the user's needs. Specifically, the reception unit receives input data such as health status data obtained from user devices or wearable devices (e.g., time-series numerical vectors of heart rate, step count, calories burned, sleep duration, body temperature, blood oxygen saturation, stress indicators, and vital sign data). The reception unit normalizes these health data in a preprocessing unit and generates feature vectors such as heart rate trends per minute (60-dimensional vector), daily step count totals, sleep scores (0.0 to 1.0), and stress levels (0 to 100). The reception unit generates health status features (e.g., fatigue score, exercise flag, illness label) and inputs them into a health status estimation AI model (e.g., LSTM-based time-series analysis model or Transformer-based multimodal health status classification model). Examples of AI model input include “Heart rate: 85 bpm, Step count: 5000, Sleep score: 0.6,” “Body temperature: 37.8° C., Stress level: 80,” etc. Examples of AI model output include “Health status: Fatigue, Score: 0.85,” “Health status: Exercising, Score: 0.92,” “Health status: Illness, Score: 0.78,” etc. Based on the health status estimation results, the reception unit retrieves attributes of each video (e.g., relaxation, exercise, health information) from the video metadata database and calculates priority scores according to matching rules between health status and video attributes (e.g., fatigue→relaxation video, exercising→exercise video, illness→health information video). The reception unit dynamically controls the order of the video list on the user interface based on the priority scores, displaying the most suitable videos for the user's health status at the top. Furthermore, the reception unit analyzes the user's health status time-series changes and history, and can recommend videos according to usage scenarios, such as “recommend rest videos for long-term fatigue trends” or “propose new exercise videos for users with exercise habits.” As a technical effect, the reception unit achieves improved user satisfaction, promotion of healthy behavior, reduction of video selection time, and increased viewing continuity through high-dimensional health status estimation and dynamic priority control by AI, compared to conventional static video recommendations and uniform ordering. Training of AI models can utilize multimodal datasets with health annotations, transfer learning, and online learning to follow health trends. Specific application fields include video recommendations for health management apps, personalized distribution of fitness videos, health information video recommendations for patients in medical settings, and automatic proposals of stress relief videos. The present invention is not merely automation of human tasks, but realizes improvement of computer technology itself through a series of technical processes including unconventional high-dimensional health status estimation by AI, priority control, and dynamic UI integration.

The reception unit can estimate the user's emotion and adjust the recommendation level of video content based on the estimated emotion of the user. For example, if the user is sad, fun videos to lift the mood are preferentially displayed. Additionally, if the user is angry, relaxing videos can be proposed. Furthermore, if the user is happy, positive videos to maintain that emotion can be displayed. By adjusting the recommendation level of video content according to the user's emotion, more appropriate videos can be provided. Specifically, the reception unit receives multimodal emotion data as input, such as input text from the user device (e.g., chat history, search queries), audio data (e.g., speech waveform data, 16 kHz sampling rate), and facial images (e.g., 224×224×3 RGB image tensor). The reception unit normalizes these data in a preprocessing unit, performing mel spectrogram conversion for audio, face region detection and facial feature extraction for images, and emotion word dictionary matching or BERT-based emotion classification for text. The reception unit integrates these feature vectors (e.g., 128-dimensional audio features, 256-dimensional image features, 300-dimensional text features) and inputs them into a multimodal emotion estimation model (e.g., Transformer-based fusion network). Examples of AI model input include “Text: ‘I'm sad today’,” “Facial image with angry expression,” “Audio clip with calm voice,” etc. Examples of AI model output include “Emotion label: Sad, Score: 0.9,” “Emotion label: Anger, Score: 0.8,” “Emotion label: Happiness, Score: 0.85,” etc. Based on the emotion estimation results, the reception unit retrieves attributes of each video (e.g., fun, relaxing, positive) from the video metadata database and calculates recommendation scores according to matching rules between emotion labels and video attributes (e.g., sad→fun video, anger→relaxing video, happiness→positive video). The reception unit dynamically controls the order of the video list on the user interface based on the recommendation scores, displaying the most suitable videos for the user's emotional state at the top. Furthermore, the reception unit analyzes the user's emotional state time-series changes and history, and can recommend videos according to usage scenarios, such as “propose mood-changing videos for long-term sadness” or “recommend new positive videos for sustained happiness.” As a technical effect, the reception unit achieves improved user satisfaction, reduced video selection time, and increased viewing continuity through high-dimensional emotion estimation and dynamic recommendation control by AI, compared to conventional static video recommendations and uniform ordering. Training of AI models can utilize multimodal datasets with emotion annotations, transfer learning, and online learning to follow emotion trends. Specific application fields include mood-linked video recommendations, automatic proposals of stress relief videos, personalized distribution of positive videos, and motivation maintenance video recommendations in educational settings. The present invention is not merely automation of human tasks, but realizes improvement of computer technology itself through a series of technical processes including unconventional high-dimensional emotion estimation by AI, recommendation control, and dynamic UI integration.

The analysis unit can estimate the user's interest and adjust the depth of analysis based on the estimated interest. For example, if the user has a strong interest in a specific topic, detailed information related to that topic is extracted. If the user has broad interests, a wide range of information can be extracted. Furthermore, if the user is interested in a specific genre, information related to that genre can be preferentially extracted. By adjusting the depth of analysis according to the user's interest, more appropriate analysis results can be provided. Specifically, the analysis unit receives input data such as user interest data (e.g., search history, viewing history, click history, bookmarks, evaluation scores, questionnaire responses, category labels, topic distribution vectors) from the reception unit or storage unit. The analysis unit normalizes these data in a preprocessing unit and generates features such as topic distribution vectors (e.g., 20-dimensional topic probability distribution), genre one-hot vectors, and interest intensity scores (0.0 to 1.0). The analysis unit inputs these features into an interest estimation AI model (e.g., BERT-based topic classification model or Transformer-based interest distribution estimation model) and receives outputs such as user interest labels (e.g., economics, sports, music, science), interest intensity scores, and genre distributions. Examples of AI model input include “Search history: AI, machine learning, deep learning,” “Viewing history: 10 sports videos, 5 music videos,” etc. Examples of AI model output include “Interest topic: AI, Score: 0.92,” “Interest genre: Sports, Score: 0.85,” “Interest distribution: Economics 0.3, Music 0.2, Science 0.5,” etc. Based on the interest estimation results, the analysis unit dynamically switches the detail level and extraction range of the analysis pipeline's depth control module. For example, if strong interest in a specific topic is estimated, detailed information (e.g., technical term explanations, related news, in-depth summaries) related to that topic is intensively extracted. If broad interest is estimated, wide-ranging information (e.g., key points for each genre, cross-topic summaries) is extracted. If high interest in a specific genre is estimated, information related to that genre (e.g., sports highlights, new music information) is preferentially extracted. These analysis depth adjustments are realized by dynamically switching AI model parameters (e.g., extraction window width, detail level, number of extraction topics) and algorithm selection (e.g., detailed analysis mode/broad analysis mode). Examples of AI model output include “Detailed analysis: 10 AI-related news items+technical term explanations,” “Broad analysis: key points extracted for each major genre,” “Genre-priority analysis: 5 sports highlights,” etc. In subsequent processing, the output of the analysis unit is passed to the generation unit and used for summary text generation, speech synthesis, and display control in the user interface. As a technical effect, the analysis unit achieves optimal analysis depth according to the user's real-time interest state, efficient use of computational resources, reduced analysis time, and increased user satisfaction, compared to conventional uniform analysis processing. Furthermore, interest estimation models can be trained using user behavior datasets annotated with interests, transfer learning, and online learning to follow trends. Specific application fields include personalized news summarization, extraction of individual learning points from educational videos, genre-based highlight generation for entertainment videos, and project-based summarization for business videos. The present invention is not merely automation of human tasks, but realizes improvement of computer technology itself through a series of technical processes including high-dimensional interest estimation by AI, analysis depth control, and unconventional information extraction.

The analysis unit can estimate the user's emotion and adjust the importance of analysis results based on the estimated emotion. For example, if the user feels stressed, analysis results that concisely summarize important information are provided. If the user is relaxed, detailed analysis results can be provided. Furthermore, if the user is excited, visually attractive analysis results can be provided. By adjusting the importance of analysis results according to the user's emotion, more appropriate analysis results can be provided. Specifically, the analysis unit receives input data such as the user's emotion estimation results (e.g., emotion label, emotion intensity score, confidence score) from the reception unit or storage unit. The analysis unit dynamically determines analysis result importance parameters (e.g., key point extraction level, detail level, emphasis level, presence of visual effects, etc.) according to emotion labels (e.g., stress, relaxation, excitement). For example, in a stress state, prompts such as “extract only key points,” “concise summary,” and “short sentence structure” are given to the natural language processing model, and visually, a simple UI is used to emphasize only the key points. In a relaxed state, prompts such as “detailed explanation,” “full summary,” and “insert charts” are generated, and detailed information is displayed in a rich UI. In an excited state, prompts such as “insert emphasized phrases,” “emphasize effects,” and “visually attractive summary” are generated, and a dynamic UI using colors and animations is generated. Examples of AI input include “Emotion label: Stress, Score: 0.9,” “Emotion label: Relaxation, Score: 0.7,” and “Emotion label: Excitement, Score: 0.8.” Examples of AI output include “Importance: High, Key points only,” “Importance: Medium, Detailed summary,” and “Importance: High, Emphasis effect.” Based on these outputs, the analysis unit optimizes display control of analysis results and data linkage to subsequent generation units. As a technical effect, the analysis unit achieves optimal importance according to the user's real-time emotional state, improving information comprehension, reducing operation error rate, and increasing user satisfaction, compared to conventional static analysis results and uniform importance settings. Furthermore, emotion estimation models and importance control models can be trained using datasets annotated with emotion states and information preferences, as well as online learning. Specific application fields include key point emphasis summarization for news videos, detailed explanation generation for educational videos, highlight emphasis analysis for entertainment videos, and stress relief summarization for business videos. The present invention is not merely automation of human tasks, but realizes improvement of computer technology itself through a series of technical processes including high-dimensional emotion estimation by AI, dynamic importance control, and unconventional analysis pipelines.

The generation unit can estimate the user's emotion and adjust the method of expressing the summary based on the estimated emotion. For example, if the user is feeling down, a summary using positive expressions is generated. If the user is excited, a summary with visually stimulating effects can be generated. Furthermore, if the user is relaxed, a summary that progresses at a leisurely pace can be generated. By adjusting the method of expressing the summary according to the user's emotion, more appropriate summaries can be provided. Specifically, the generation unit receives input data such as the user's emotion estimation results (e.g., emotion label, emotion intensity score, confidence score) from the reception unit or analysis unit. Based on the emotion estimation results, the generation unit dynamically determines summary generation parameters (e.g., writing style, tone, progression speed, effect intensity, presence of visual elements, etc.). For example, if the user is feeling down, prompts such as “positive expression,” “insert encouraging phrases,” and “bright tone” are given to the natural language generation model, and soft, bright voice parameters are set for the speech synthesis model. In an excited state, scripts and metadata for “inserting emphasized phrases” and “visual effects (e.g., color emphasis, animation)” are generated, and dynamic effects are applied to video summary thumbnails and UI. In a relaxed state, prompts such as “polite and calm tone,” “detailed explanation,” and “leisurely progression” are given, and slow, soft voice parameters are set for the speech synthesis model. Examples of AI input include “Emotion label: Feeling down, Score: 0.8,” “Emotion label: Excitement, Score: 0.9,” and “Emotion label: Relaxation, Score: 0.7.” Examples of AI output include “Summary style: Positive/Encouraging,” “Summary style: With emphasized phrases, Effect: Color emphasis,” and “Summary style: Polite/Detailed, Progression speed: Slow.” Based on these outputs, the generation unit automatically sets parameters for the summary generation algorithm (e.g., summary length, style template, speech synthesis speed, effect script) and controls branching of the summary generation pipeline. In subsequent processing, the generated summary is linked to the storage unit or user interface and presented in an expression optimized for the user's emotional state. As a technical effect, the generation unit achieves optimal expression according to the user's real-time emotional state, improving information comprehension, increasing user satisfaction, and reducing operation error rate, compared to conventional uniform summary generation. Furthermore, emotion estimation models and summary generation models can be trained using datasets annotated with emotion states and expression preferences, as well as online learning. Specific application fields include mood-linked summary generation, stress relief summaries, mood-changing summaries for entertainment videos, and motivation maintenance summaries for educational videos. The present invention is not merely automation of human tasks, but realizes improvement of computer technology itself through a series of technical processes including high-dimensional emotion estimation by AI, dynamic summary expression control, and unconventional generation pipelines.

The generation unit can analyze the user's past summary usage history and adjust the summary generation method based on usage frequency. For example, summary formats frequently used by the user are preferentially generated. Additionally, summaries used by the user at specific times can be generated to match those time periods. Furthermore, summaries used by the user on specific devices can be optimized for those devices during generation. By adjusting the summary generation method based on the user's past usage history, more appropriate summaries can be provided. Specifically, the generation unit receives input data such as the user's summary usage history (e.g., summary format selection history, time-series usage frequency data, device type, usage time period, preferred summary length, preferred UI display, etc.) from the storage unit or reception unit. The generation unit normalizes these history data in a preprocessing unit and generates features such as summary format one-hot vectors, usage frequency histograms (e.g., 168-dimensional vector for 24 hours×7 days), device type embedding vectors, and time period features. The generation unit inputs these features into a history analysis AI model (e.g., time-series LSTM model or Transformer-based usage pattern classification model) and receives outputs such as optimal summary generation parameters (e.g., format, length, display method, device optimization parameters). Examples of AI input include “Usage history for past 30 days: 20 short summaries, 5 detailed summaries,” “Frequent usage at night,” “Device: Smartphone,” etc. Examples of AI output include “Recommended summary format: Short, Length: 200 characters, Device optimization: Smartphone UI,” “Recommended summary format: Detailed, Length: 1000 characters, Device optimization: Tablet UI,” etc. Based on these outputs, the generation unit automatically sets parameters for the summary generation algorithm (e.g., summary length, display template, device optimization settings) and controls branching of the summary generation pipeline. In subsequent processing, the generated summary is linked to the storage unit or user interface and presented in a format optimized for the user's usage history. As a technical effect, the generation unit achieves optimal generation methods based on the user's past usage history, improving information comprehension, increasing user satisfaction, and reducing operation error rate, compared to conventional uniform summary generation. Furthermore, history analysis models and summary generation models can be trained using datasets annotated with usage history and online learning. Specific application fields include personalized summary generation, time-based summary distribution, device-optimized summary generation, and usage pattern-linked summaries for business settings. The present invention is not merely automation of human tasks, but realizes improvement of computer technology itself through a series of technical processes including high-dimensional history analysis by AI, dynamic generation method control, and unconventional generation pipelines.

The generation unit can estimate the user's emotion and adjust the length of the summary based on the estimated emotion. For example, if the user is in a hurry, a short summary focusing on key points is generated. If the user is relaxed, a longer summary including detailed explanations can be generated. Furthermore, if the user is excited, a summary with visually stimulating effects can be generated. By adjusting the length of the summary according to the user's emotion, more appropriate summaries can be provided. Specifically, the generation unit receives input data such as the user's emotion estimation results (e.g., emotion label, emotion intensity score, confidence score) from the reception unit or analysis unit. Based on the emotion estimation results, the generation unit dynamically determines summary generation parameters (e.g., summary length, number of sentences, detail level, effect intensity, etc.). For example, if the user is in a hurry, prompts such as “key points only,” “short sentence structure,” and “maximum 200 characters” are given to the natural language generation model, and fast, concise voice parameters are set for the speech synthesis model. In a relaxed state, prompts such as “detailed explanation,” “long sentence structure,” and “maximum 1000 characters” are generated, and slow, soft voice parameters are applied to the speech synthesis model. In an excited state, prompts such as “insert emphasized phrases,” “emphasize effects,” and “medium to long sentence structure” are generated, and dynamic effects are applied to video summary thumbnails and UI. Examples of AI input include “Emotion label: In a hurry, Score: 0.9,” “Emotion label: Relaxation, Score: 0.7,” and “Emotion label: Excitement, Score: 0.8.” Examples of AI output include “Summary length: 150 characters, Detail level: Low,” “Summary length: 900 characters, Detail level: High,” and “Summary length: 500 characters, Effect: Emphasis.” Based on these outputs, the generation unit automatically sets parameters for the summary generation algorithm (e.g., summary length, detail level, effect) and controls branching of the summary generation pipeline. In subsequent processing, the generated summary is linked to the storage unit or user interface and presented at a length optimized for the user's emotional state. As a technical effect, the generation unit achieves optimal summary length according to the user's real-time emotional state, improving information comprehension, increasing user satisfaction, and reducing operation error rate, compared to conventional uniform summary lengths. Furthermore, emotion estimation models and summary generation models can be trained using datasets annotated with emotion states and preferred summary lengths, as well as online learning. Specific application fields include dynamic control of summary length for news videos, learning mode-optimized summaries for educational videos, highlight emphasis summary generation for entertainment videos, and stress relief summaries for business videos. The present invention is not merely automation of human tasks, but realizes improvement of computer technology itself through a series of technical processes including high-dimensional emotion estimation by AI, dynamic summary length control, and unconventional generation pipelines.

The storage unit can estimate the user's emotion and determine the priority order of summaries to be stored based on the estimated emotion. For example, summaries that the user feels are important are preferentially stored. Additionally, if the user is relaxed, detailed summaries can be preferentially stored. Furthermore, if the user is in a hurry, concise summaries can be preferentially stored. By determining the priority order of summaries to be stored according to the user's emotion, more important summaries can be preferentially stored. Specifically, the storage unit receives input data such as the user's emotion estimation results (e.g., emotion label, emotion intensity score, confidence score) from the reception unit or analysis unit. Based on the emotion estimation results, the storage unit dynamically determines parameters for calculating the priority score of summaries to be stored (e.g., continuous values from 0.0 to 1.0). For example, if the emotion label is estimated as “important,” an “importance flag” is added to the summary content and the priority score is maximized. In a relaxed state, a high priority is assigned to detailed summaries (e.g., full transcription or summaries with detailed explanations). In a hurry, priority is given to concise summaries that extract only the main points. Examples of AI input include “Emotion label: Important, Score: 0.95,” “Emotion label: Relaxed, Score: 0.7,” and “Emotion label: In a hurry, Score: 0.85.” Examples of AI output include “Storage priority: High, Reason: Important emotion,” “Storage priority: Medium, Reason: Detailed summary,” and “Storage priority: Low, Reason: Concise summary.” Based on these outputs, the storage unit automatically controls the order of the storage queue and storage allocation, storing summaries in cloud or local storage in order of priority. Furthermore, the storage unit adds metadata to the summaries to be stored (e.g., emotion label, priority score, storage date and time, category, etc.), enabling optimization based on priority in subsequent search, viewing, and deletion processes. As a technical effect, the storage unit achieves optimization of storage priority according to the user's real-time emotional state, preventing omission of important information, efficient use of storage resources, and increased user satisfaction, compared to conventional uniform storage order and static storage rules. Additionally, emotion estimation models and storage priority estimation models can be trained using datasets annotated with emotion states and storage behaviors, as well as online learning. Specific application fields include prioritized storage of important summaries for emergency news videos, storage of detailed summaries for educational videos, storage of simple highlights for entertainment videos, and prioritized storage of important minutes for business videos by project. The present invention is not merely automation of human tasks, but realizes improvement of computer technology itself through a series of technical processes including high-dimensional emotion estimation by AI, dynamic storage priority control, and unconventional storage pipelines.

The storage unit can also adjust the storage method based on the importance of the summary at the time of storage. For example, important summaries are stored in cloud storage and made accessible at any time. Additionally, general summaries can be stored in local storage and made accessible offline. Furthermore, temporary summaries can be stored so that they are automatically deleted after a certain period. By adjusting the storage method based on the importance of the summary, more appropriate storage is possible. Specifically, the storage unit receives input data such as summary importance scores (e.g., continuous values from 0.0 to 1.0), category labels, user-specified priority, and attention indicators based on viewing history, which are received from the generation unit or analysis unit. Based on this importance data, the storage unit dynamically determines storage method parameters (e.g., type of storage destination, storage period, access permissions, backup availability, etc.). For example, for summaries with high importance scores, multiple copies are stored in cloud storage or distributed file systems to ensure redundancy and availability. For general summaries, they are stored in the user's local storage or temporary cache area, prioritizing offline access and fast retrieval. For temporary summaries, expiration metadata (e.g., storage date+7 days) is added at the time of storage, and an automatic deletion job is executed when the expiration date arrives. Examples of AI input include “Summary ID: 12345, Importance: 0.95,” “Summary ID: 67890, Importance: 0.60,” and “Summary ID: 54321, Importance: 0.30.” Examples of AI output include “Storage destination: Cloud, Storage period: Unlimited,” “Storage destination: Local, Storage period: 30 days,” and “Storage destination: Temporary cache, Storage period: 7 days.” Based on these outputs, the storage unit automatically sets the storage destination and storage period in the storage management module and controls branching of the storage pipeline. Furthermore, the storage unit dynamically sets access permissions and backup policies for each storage destination to reduce the risk of loss of important summaries. As a technical effect, the storage unit achieves optimization of storage methods according to the importance of each summary, efficient use of storage resources, reduction of information loss risk, and increased user satisfaction, compared to conventional uniform storage methods and static storage allocation. Additionally, importance estimation models and storage management models can be trained using importance-annotated summary datasets and online learning. Specific application fields include multiple storage of emergency news summaries, long-term storage of educational video summaries, temporary storage of entertainment video highlights, and time-limited storage of business minutes. The present invention is not merely automation of human tasks, but realizes improvement of computer technology itself through a series of technical processes including high-dimensional importance estimation by AI, dynamic storage method control, and unconventional storage management.

The storage unit can also apply different storage methods for each summary category at the time of storage. For example, summaries in the news category are organized and stored by date. Additionally, summaries in the education category can be stored by dividing them into folders by topic. Furthermore, summaries in the entertainment category can be stored in order of popularity based on the number of views. By applying storage methods according to the summary category, more appropriate storage is possible. Specifically, the storage unit receives input data such as category labels (e.g., news, education, entertainment, etc.), summary ID, title, tag, publication date, and number of views, which are received from the generation unit or analysis unit. Based on this category data, the storage unit dynamically determines storage method parameters (e.g., folder structure, storage destination directory, order, index key, etc.). For example, in the news category, folders are automatically created by publication or issue date, and a date-ordered index is generated. In the education category, subfolders are created by topic or subject name, and related summaries are grouped. In the entertainment category, summaries are sorted by number of views or user evaluation score and stored with rankings. Examples of AI input include “Summary ID: 12345, Category: News, Publication Date: 2024-06-01,” “Summary ID: 67890, Category: Education, Topic: AI,” and “Summary ID: 54321, Category: Entertainment, Views: 1000.” Examples of AI output include “Storage destination: /news/2024-06-01/”, “Storage destination: /education/AI/”, and “Storage destination: /entertainment/ranking/1/”. Based on these outputs, the storage unit automatically sets the storage destination directory and index in the file system management module and controls branching of the storage pipeline. Furthermore, the storage unit optimizes the search, viewing, and deletion interfaces for each category, enabling users to quickly access the desired summary. As a technical effect, the storage unit achieves optimal application of storage methods for each category, reduction of information search costs, improvement of search efficiency, and increased user satisfaction, compared to conventional uniform storage structures and static folder organization. Additionally, category classification models and storage method optimization models can be trained using category-annotated summary datasets and online learning. Specific application fields include date-based archiving of news summaries, topic-based organization of educational video summaries, popularity-based storage of entertainment video highlights, and project-based storage of business minutes. The present invention is not merely automation of human tasks, but realizes improvement of computer technology itself through a series of technical processes including high-dimensional category classification by AI, dynamic storage method control, and unconventional file management.

Below, the processing flow of Example of the Embodiment is briefly described. Specifically, the system operates in cooperation among the reception unit, analysis unit, generation unit, and storage unit, executing a series of processes from user input to video designation, content analysis, summary generation, and storage in a stepwise and dynamic manner. The system exchanges feature vectors and metadata as structured data between modules, realizing high-dimensional feature extraction, estimation, generation, and storage control by AI models. At each step, various input data such as user emotion, health status, interest, and usage history are input into multimodal AI models, and estimation results and control parameters are linked to subsequent processing, thereby achieving technical effects such as optimization of personalization degree, improvement of analysis accuracy, reduction of information search cost, and increased user satisfaction compared to conventional static video summarization and storage systems. Furthermore, the system can enhance interoperability and scalability with other systems through API integration and microservices for each module. Specific application fields include summarization of medical records in medical settings, individualized learning support in educational settings, personalized summary distribution in entertainment fields, and automatic organization of minutes in business fields. The present invention is not merely automation of human tasks, but realizes improvement of computer technology itself through a series of technical processes including high-dimensional feature extraction by AI, dynamic pipeline control, and unconventional system configuration optimization.

Step 1: The reception unit designates the video content that the user wishes to view. For example, the user designates “today's news video.” This information is input to the reception unit. Step 2: The analysis unit analyzes the video content designated by the reception unit. The analysis unit understands the content of the video and extracts important information. For example, in the case of a news video, major news items and important statements are extracted. Step 3: The generation unit creates a summary based on the content analyzed by the analysis unit. The summary is generated by transcription or speech synthesis. For example, as a summary of a news video, a transcription listing major news items or a speech-synthesized summary is generated. Step 4: The storage unit stores the summary generated by the generation unit. By storing the summary, it is possible to review the video content even after it has been deleted. For example, the user can later check the summary of the saved news video. Specifically, the system receives user input (e.g., video title, search query, health status, emotion data, etc.) at the reception unit, performs normalization and feature extraction in the preprocessing unit, executes AI analysis of video content (e.g., category classification, important information extraction, emotion/interest estimation) in the analysis unit, dynamically determines summary generation parameters (e.g., summary length, style, effects, etc.) in the generation unit to generate the summary, and automatically controls the storage destination and priority in the storage unit. At each step, examples of AI model input and output are specified, and the usage methods in subsequent processing (e.g., UI display, search, reuse) are designed in detail, thereby achieving technical effects such as optimization of personalization degree, improvement of analysis accuracy, reduction of information search cost, and increased user satisfaction compared to conventional static processing flows. The present invention is not merely automation of human tasks, but realizes improvement of computer technology itself through a series of technical processes including high-dimensional feature extraction by AI, dynamic pipeline control, and unconventional system configuration optimization.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned reception unit, analysis unit, generation unit, and storage unit is implemented by at least one of, for example, the smart device 14 and the data processing apparatus 12. For example, the reception unit is implemented by a control unit 46A of the smart device 14 and is configured to designate video content that the user wishes to view. The analysis unit is implemented, for example, by a specific processing unit 290 of the data processing apparatus 12 and is configured to analyze the designated video content and extract important information. The generation unit is implemented, for example, by the specific processing unit 290 of the data processing apparatus 12 and is configured to create a summary based on the analyzed content. The storage unit is implemented, for example, by the specific processing unit 290 of the data processing apparatus 12 and is configured to store the generated summary. The correspondence between each unit and the device or control unit is not limited to the examples described above and various modifications are possible.

### Second Embodiment

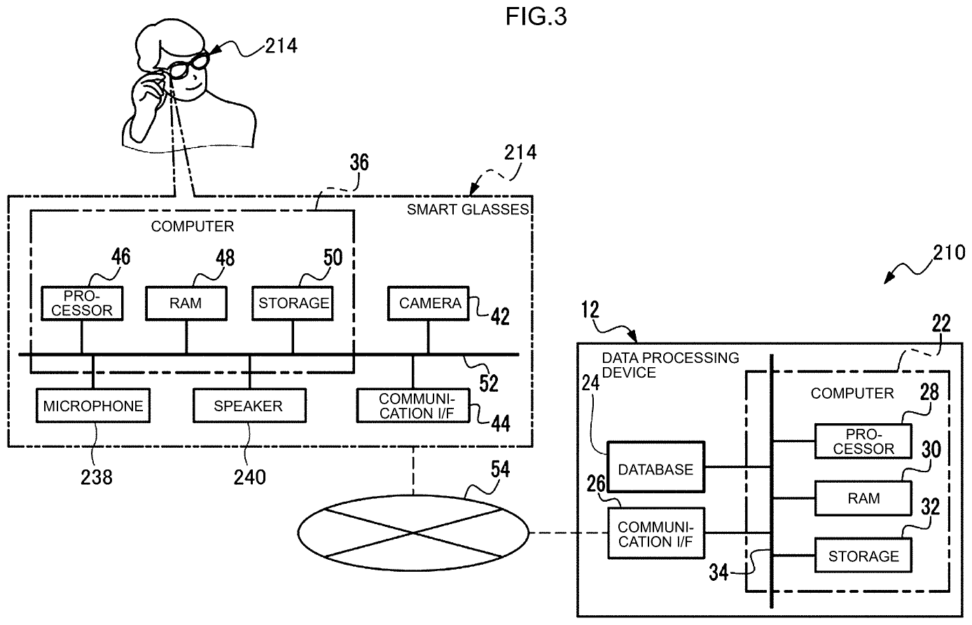

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

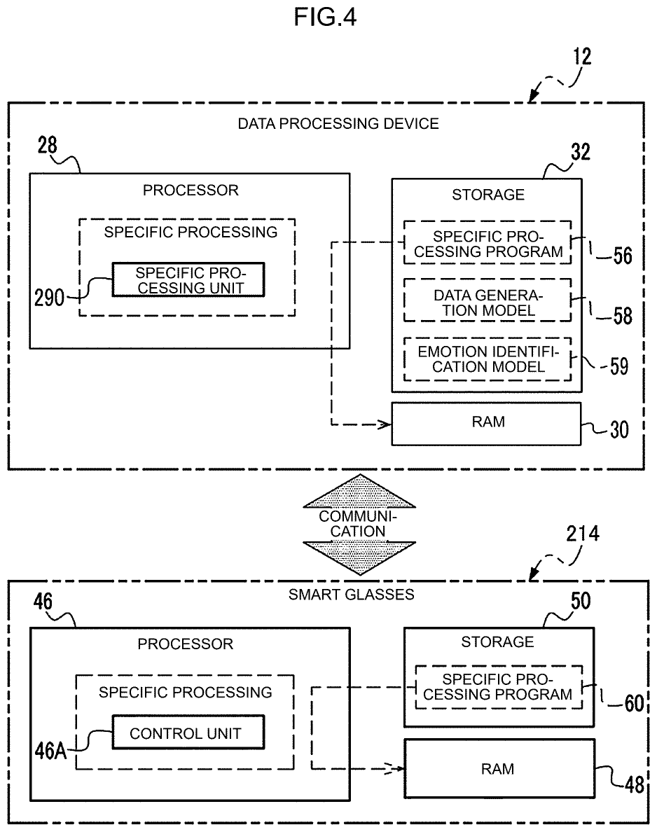

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned reception unit, analysis unit, generation unit, and storage unit is implemented by at least one of, for example, the smart glasses 214 and the data processing apparatus 12. For example, the reception unit is implemented by a control unit 46A of the smart glasses 214 and is configured to designate video content that the user wishes to view. The analysis unit is implemented, for example, by a specific processing unit 290 of the data processing apparatus 12 and is configured to analyze the designated video content and extract important information. The generation unit is implemented, for example, by the specific processing unit 290 of the data processing apparatus 12 and is configured to create a summary based on the analyzed content. The storage unit is implemented, for example, by the specific processing unit 290 of the data processing apparatus 12 and is configured to store the generated summary. The correspondence between each unit and the device or control unit is not limited to the examples described above and various modifications are possible.

### Third Embodiment

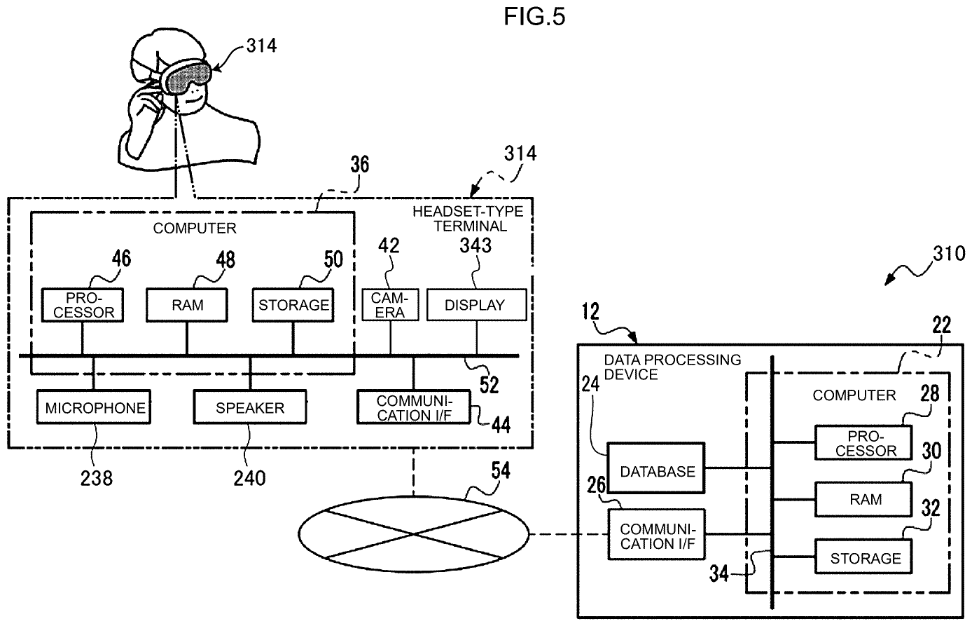

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

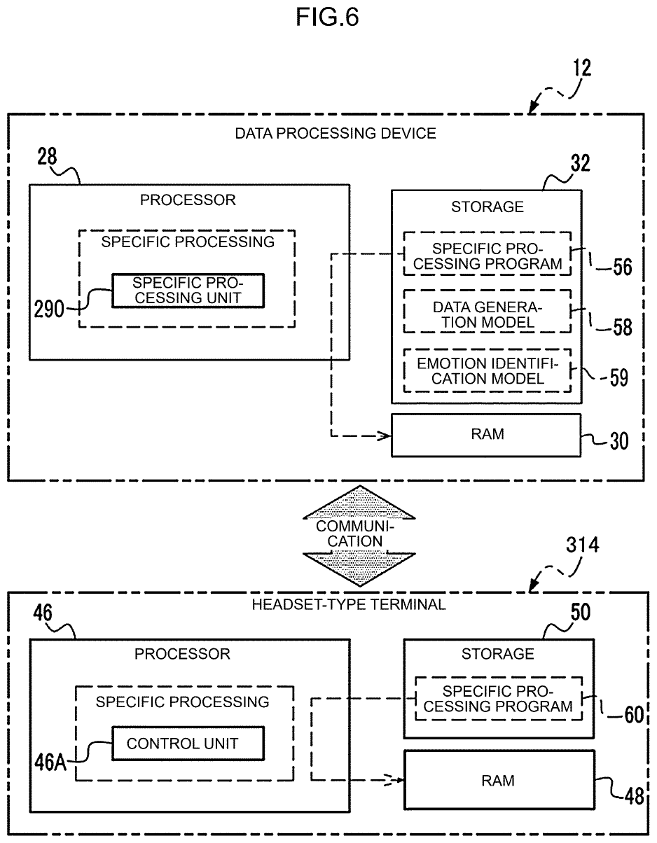

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned reception unit, analysis unit, generation unit, and storage unit is implemented by at least one of, for example, the headset-type terminal 314 and the data processing apparatus 12. For example, the reception unit is implemented by a control unit 46A of the headset-type terminal 314 and is configured to designate video content that the user wishes to view. The analysis unit is implemented, for example, by a specific processing unit 290 of the data processing apparatus 12 and is configured to analyze the designated video content and extract important information. The generation unit is implemented, for example, by the specific processing unit 290 of the data processing apparatus 12 and is configured to create a summary based on the analyzed content. The storage unit is implemented, for example, by the specific processing unit 290 of the data processing apparatus 12 and is configured to store the generated summary. The correspondence between each unit and the device or control unit is not limited to the examples described above and various modifications are possible.

### Fourth Embodiment

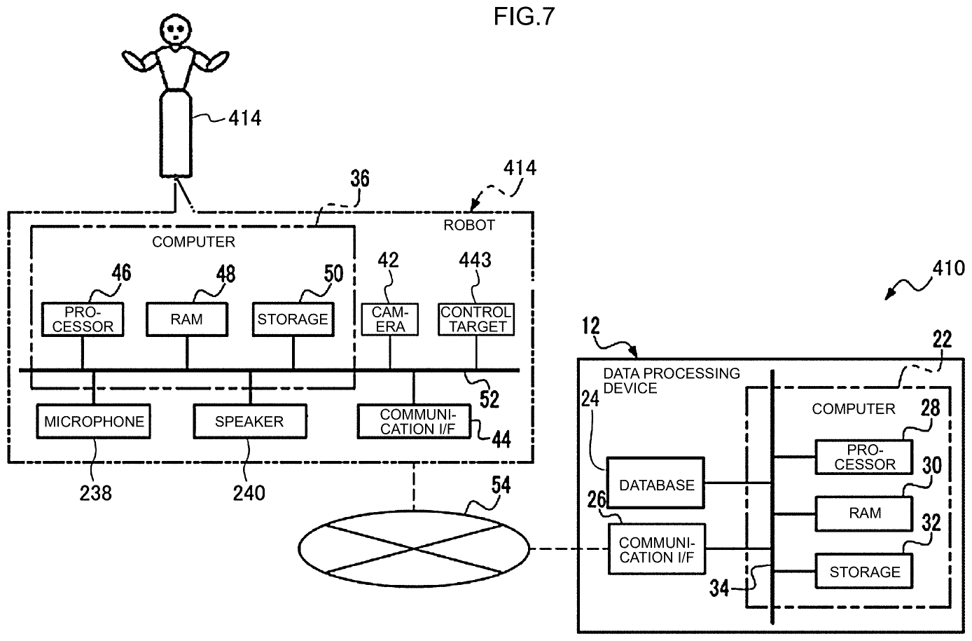

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

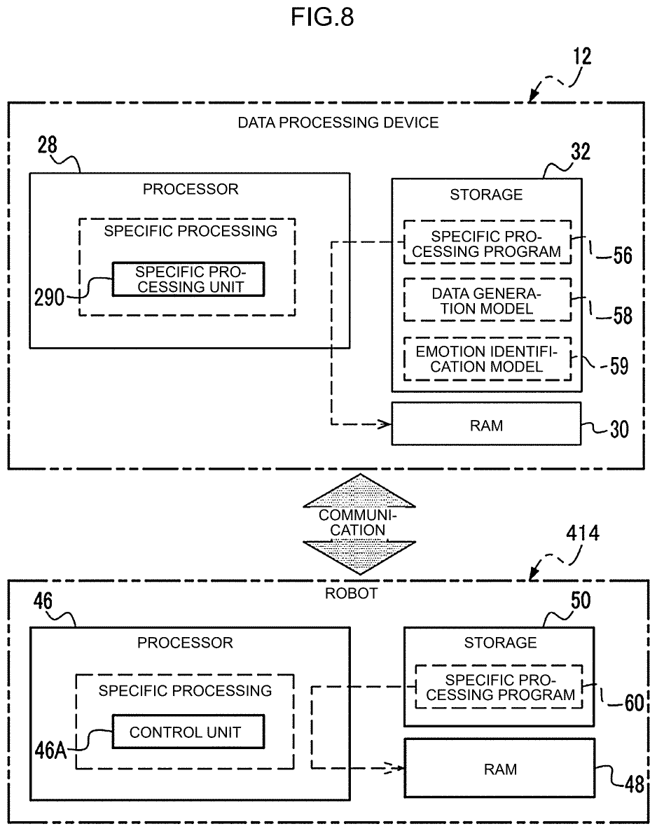

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned reception unit, analysis unit, generation unit, and storage unit is implemented by at least one of, for example, the robot 414 and the data processing apparatus 12. For example, the reception unit is implemented by a control unit 46A of the robot 414 and is configured to designate video content that the user wishes to view. The analysis unit is implemented, for example, by a specific processing unit 290 of the data processing apparatus 12 and is configured to analyze the designated video content and extract important information. The generation unit is implemented, for example, by the specific processing unit 290 of the data processing apparatus 12 and is configured to create a summary based on the analyzed content. The storage unit is implemented, for example, by the specific processing unit 290 of the data processing apparatus 12 and is configured to store the generated summary. The correspondence between each unit and the device or control unit is not limited to the examples described above and various modifications are possible.

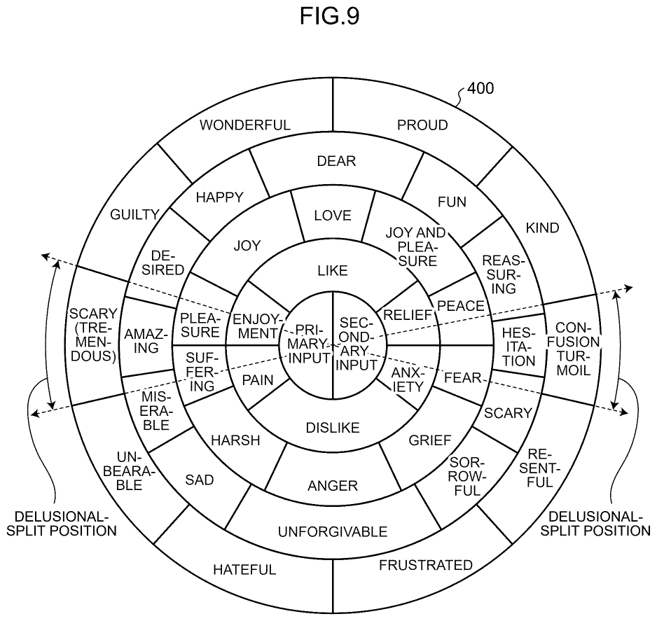

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

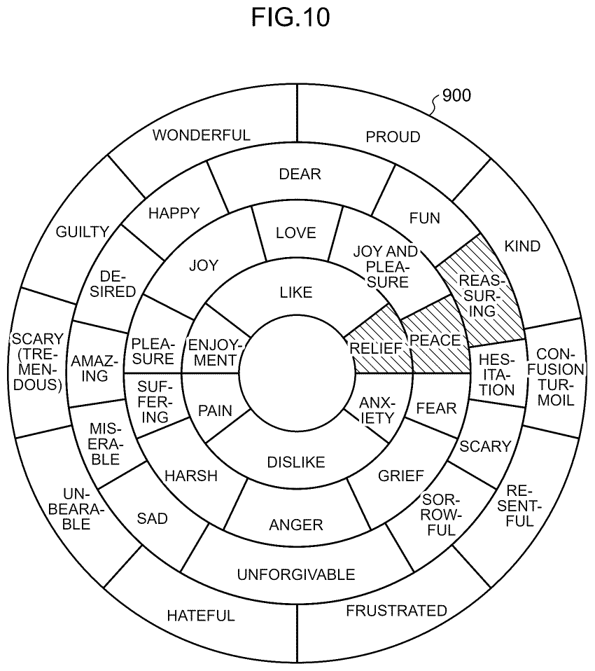

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1)A system comprising: a reception unit configured to receive a designation of video content; an analysis unit configured to analyze the video content designated by the reception unit; a generation unit configured to create a summary based on the content analyzed by the analysis unit; and a storage unit configured to store the summary generated by the generation unit.
(Supplementary Note 2)The system according to Supplementary Note 1, wherein the reception unit is configured to estimate a user's emotion and adjust a method for designating video content based on the estimated emotion of the user.
(Supplementary Note 3)The system according to Supplementary Note 1, wherein the reception unit is configured to analyze a user's past video viewing history and automatically propose appropriate video content.
(Supplementary Note 4)The system according to Supplementary Note 1, wherein the reception unit is configured to perform filtering based on a user's current field of interest when designating video content.
(Supplementary Note 5)The system according to Supplementary Note 1, wherein the reception unit is configured to estimate a user's emotion and determine a priority order of video content to be designated based on the estimated emotion of the user.
(Supplementary Note 6)The system according to Supplementary Note 1, wherein the reception unit is configured to preferentially designate highly relevant content based on a user's geographic location information when designating video content.
(Supplementary Note 7)The system according to Supplementary Note 1, wherein the reception unit is configured to analyze a user's social media activity and propose related content when designating video content.
(Supplementary Note 8)The system according to Supplementary Note 1, wherein the analysis unit is configured to estimate a user's emotion and adjust the accuracy of analysis based on the estimated emotion of the user.
(Supplementary Note 9)The system according to Supplementary Note 1, wherein the analysis unit is configured to apply different analysis algorithms according to the content of the video during analysis.
(Supplementary Note 10)The system according to Supplementary Note 1, wherein the analysis unit is configured to apply different important information extraction methods for each video category during analysis.
(Supplementary Note 11)The system according to Supplementary Note 1, wherein the analysis unit is configured to estimate a user's emotion and adjust a display method of analysis results based on the estimated emotion of the user.
(Supplementary Note 12)The system according to Supplementary Note 1, wherein the analysis unit is configured to perform analysis based on the geographic distribution of the video during analysis.
(Supplementary Note 13)The system according to Supplementary Note 1, wherein the analysis unit is configured to improve the accuracy of analysis based on related literature of the video during analysis.
(Supplementary Note 14)The system according to Supplementary Note 1, wherein the generation unit is configured to estimate a user's emotion and adjust a method for expressing the summary based on the estimated emotion of the user.
(Supplementary Note 15)The system according to Supplementary Note 1, wherein the generation unit is configured to adjust a level of detail of the summary based on the importance of the video when generating the summary.
(Supplementary Note 16)The system according to Supplementary Note 1, wherein the generation unit is configured to apply different summary generation algorithms according to the category of the video when generating the summary.
(Supplementary Note 17)The system according to Supplementary Note 1, wherein the generation unit is configured to estimate a user's emotion and adjust a length of the summary based on the estimated emotion of the user.
(Supplementary Note 18)The system according to Supplementary Note 1, wherein the generation unit is configured to determine a priority order of the summary based on the submission timing of the video when generating the summary.
(Supplementary Note 19)The system according to Supplementary Note 1, wherein the generation unit is configured to adjust an order of the summary based on the relevance of the video when generating the summary.
(Supplementary Note 20)The system according to Supplementary Note 1, wherein the storage unit is configured to estimate a user's emotion and determine a priority order of the summary to be stored based on the estimated emotion of the user.
(Supplementary Note 21)The system according to Supplementary Note 1, wherein the storage unit is configured to adjust a storage method based on the importance of the summary when storing.
(Supplementary Note 22)The system according to Supplementary Note 1, wherein the storage unit is configured to apply different storage methods for each summary category when storing.
(Supplementary Note 23)The system according to Supplementary Note 1, wherein the storage unit is configured to estimate a user's emotion and adjust a display method of the summary to be stored based on the estimated emotion of the user.
(Supplementary Note 24)The system according to Supplementary Note 1, wherein the storage unit is configured to perform storage based on the geographic distribution of the summary when storing.
(Supplementary Note 25)The system according to Supplementary Note 1, wherein the storage unit is configured to improve the accuracy of storage based on related literature of the summary when storing.

What is claimed is:

1. A system comprising:
a communication interface configured to communicate with a client terminal via a packet-switched network;
a memory storing a data generation model obtained by deep learning on a neural network, and an emotion identification model;
a database; and
circuitry configured to:
receive, from the client terminal via the communication interface, designation data identifying video content;
analyze the video content by dividing the video content into frame data and audio stream data, extracting feature vectors from the frame data using a convolutional neural network, and extracting acoustic features from the audio stream data;
generate, using the data generation model, summary data comprising at least one of text data or audio data based on the extracted feature vectors and the extracted acoustic features;
store the summary data together with metadata in the database; and
transmit the summary data to the client terminal via the communication interface and the packet-switched network, the summary data causing the client terminal to present the summary data to a user.

2. The system according to claim 1, wherein the frame data comprises image tensors, and wherein the audio stream data comprises mel spectrogram arrays.

3. The system according to claim 1, wherein the circuitry is further configured to extract the acoustic features using at least one of a recurrent neural network or a Transformer-based speech recognition model.

4. The system according to claim 1, wherein the circuitry is further configured to generate the summary data by inputting the extracted feature vectors and the extracted acoustic features into a natural language generation model comprising a large language model.

5. The system according to claim 1, wherein the circuitry is further configured to generate speech-synthesized audio data from the summary data using a deep learning-based speech synthesis model.

6. The system according to claim 1, wherein the metadata comprises at least one of a video identifier, a generation timestamp, a category label, or a summary content type.

7. The system according to claim 1, wherein the circuitry is further configured to estimate an emotion of the user by applying the emotion identification model to at least one of voice data, a face image, or text input received from the client terminal, and to adjust an accuracy of the analysis based on the estimated emotion.

8. The system according to claim 7, wherein the circuitry is configured to perform detailed frame-by-frame analysis when the estimated emotion indicates relaxation, and to extract only portions with high importance scores when the estimated emotion indicates urgency.

9. The system according to claim 1, wherein the circuitry is further configured to apply different analysis algorithms according to a category of the video content, such that for news video content, the circuitry applies a key phrase extraction algorithm, and for educational video content, the circuitry applies a learning point extraction algorithm.

10. The system according to claim 1, wherein the circuitry is further configured to estimate an emotion of the user by applying the emotion identification model to sensor data received from the client terminal, and to adjust an expression style of the summary data based on the estimated emotion.

11. The system according to claim 10, wherein the circuitry is configured to generate the summary data in a concise expression style when the estimated emotion indicates urgency, and to generate the summary data in a detailed expression style when the estimated emotion indicates relaxation.

12. The system according to claim 1, wherein the circuitry is further configured to adjust a level of detail of the summary data based on an importance score associated with the video content.

13. The system according to claim 1, wherein the circuitry is further configured to apply different summary generation algorithms according to a category of the video content.

14. The system according to claim 1, wherein the circuitry is further configured to determine a priority of generating the summary data based on a submission timing associated with the video content, such that video content having a more recent submission timing is processed with a higher priority.

15. The system according to claim 1, wherein the circuitry is further configured to estimate an emotion of the user and to determine a priority order of storing the summary data in the database based on the estimated emotion.

16. The system according to claim 1, wherein the circuitry is further configured to adjust a storage method based on an importance score of the summary data, such that summary data having a high importance score is stored in cloud storage with redundancy, and summary data having a low importance score is stored in temporary storage with an expiration period.

17. The system according to claim 1, wherein the circuitry is further configured to index the summary data stored in the database to enable search and retrieval of the summary data after the video content has been deleted.

18. A system comprising:
a communication interface configured to communicate, via a packet-switched network conforming to at least one of a 5G, Wi-Fi, or Bluetooth communication standard, with a client terminal comprising a touch panel, a microphone, a speaker, a camera having a CMOS image sensor, and a display;
a processor;
a random-access memory;
a memory storing a data generation model obtained by deep learning on a neural network, and an emotion identification model;
a database; and
circuitry configured to:
receive, from the client terminal via the communication interface, designation data identifying video content;
analyze the video content by dividing the video content into frame data comprising image tensors and audio stream data comprising mel spectrogram arrays, extracting feature vectors from the frame data using a convolutional neural network, and extracting acoustic features from the audio stream data using at least one of a recurrent neural network or a Transformer-based model;
estimate an emotion of the user by applying the emotion identification model to at least one of voice data captured by the microphone or image data captured by the camera;
generate, using the data generation model, summary data comprising at least one of text data or speech-synthesized audio data based on the extracted feature vectors, the extracted acoustic features, and the estimated emotion;
store the summary data together with metadata comprising at least one of a video identifier, a generation timestamp, or a category label in the database; and
transmit the summary data to the client terminal via the communication interface, the summary data causing the client terminal to present the summary data to the user via at least one of the display or the speaker.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a system comprising a communication interface, a memory storing a data generation model obtained by deep learning on a neural network and an emotion identification model, and a database, the method comprising:
receiving, from a client terminal via the communication interface and a packet-switched network, designation data identifying video content;
analyzing the video content by dividing the video content into frame data and audio stream data, extracting feature vectors from the frame data using a convolutional neural network, and extracting acoustic features from the audio stream data;
generating, using the data generation model, summary data comprising at least one of text data or audio data based on the extracted feature vectors and the extracted acoustic features;
storing the summary data together with metadata in the database; and
transmitting the summary data to the client terminal via the communication interface and the packet-switched network, the summary data causing the client terminal to present the summary data to a user.
